(19) United States
(12) Patent Application Publication
(10) Pub. No.: US 2022/0222583 A1
(43) Pub. Date: Jul. 14, 2022

(54) APPARATUS, ARTICLES OF MANUFACTURE, AND METHODS FOR CLUSTERED FEDERATED LEARNING USING CONTEXT DATA

(71) Applicant: INTEL CORPORATION, Santa Clara, CA (US)

(72) Inventor: Rita Wouhaybi, Portland, OR (US)

(21) Appl. No.: 17/709,237

(22) Filed: Mar. 30, 2022

(51) Int. Cl. G06N 20/00; G06K 9/62; H04L 67/10

(52) U.S. Cl. CPC G06N 20/00; H04L 67/10; G06K 9/6256; G06K 9/6218

(57) ABSTRACT

Methods, apparatus, systems, and articles of manufacture are disclosed for clustered federated learning. An example apparatus includes at least one memory, instructions, and processor circuitry to at least one of instantiate or execute the instructions to retrain a portion of a machine learning model based on context data from a first node, and cause deployment of the portion of the machine learning model to at least one of the first node or a second node to execute a workload, the second node associated with the context data.

### FIELD OF THE DISCLOSURE

This disclosure relates generally to machine learning and, more particularly, to apparatus, articles of manufacture, and methods for clustered federated learning using context data.

### BACKGROUND

Machine learning models, such as neural networks, are useful tools that have demonstrated their value solving complex problems regarding pattern recognition, natural language processing, automatic speech recognition, etc. Neural networks are arranged in layers that process data from an input layer to an output layer and apply weighting values to the data during the processing of the data. Such weighting values are determined during a training process. Federated learning enables devices to train neural networks locally using data observed by the devices and sends the new weights to a central location for integration into other machine learning models.

### BRIEF DESCRIPTION OF THE DRAWINGS

FIG. 1 is an illustration of an example federated learning system, which includes an example model handler instantiated by example machine readable instructions, example processor circuitry, and/or the example machine readable instructions to be executed by the example processor circuitry, to improve training of machine learning models based on context data associated with example nodes of example environments.

FIG. 2 is a block diagram of example model handler circuitry that may implement the example model handler of FIG. 1.

FIG. 3 is an illustration of an example implementation of the nodes and environments of FIG. 1.

FIG. 4 is an illustration of arranging the example nodes of FIGS. 1 and/or 3 into example clusters.

FIG. 5 is an illustration of an example implementation of the machine learning models of FIG. 1.

FIG. 6 is an illustration of an example implementation of the machine learning models of FIGS. 1 and/or 5.

FIG. 7 is an illustration of an example implementation of the machine learning models of FIGS. 1, 5, and/or 6.

FIG. 8 is a flowchart representative of example machine readable instructions and/or example operations that may be executed by example processor circuitry to implement the example model handler circuitry of FIG. 2 to deploy a portion of a machine learning model in a federated learning system.

FIG. 9 is another flowchart representative of example machine readable instructions and/or example operations that may be executed by example processor circuitry to implement the example model handler circuitry of FIG. 2 to deploy a portion of a machine learning model in a federated learning system.

FIG. 10 is a flowchart representative of example machine readable instructions and/or example operations that may be executed by example processor circuitry to implement the example model handler circuitry of FIG. 2 to retrain a machine learning model based on context data associated with machine learning output(s).

FIG. 11 is a flowchart representative of example machine readable instructions and/or example operations that may be executed by example processor circuitry to implement the example model handler circuitry of FIG. 2 to retrain a machine learning model at a local node.

FIG. 12 is a flowchart representative of example machine readable instructions and/or example operations that may be executed by example processor circuitry to implement the example model handler circuitry of FIG. 2 to update a machine learning model at a remote node.

FIG. 13 is a flowchart representative of example machine readable instructions and/or example operations that may be executed by example processor circuitry to implement the example model handler circuitry of FIG. 2 to retrain a machine learning model at a remote node.

FIG. 14 is a block diagram of an example processing platform including processor circuitry structured to execute the example machine readable instructions and/or the example operations of FIGS. 8-13 to implement the example model handler circuitry of FIG. 2.

FIG. 15 is a block diagram of an example implementation of the processor circuitry of FIG. 14.

FIG. 16 is a block diagram of another example implementation of the processor circuitry of FIG. 14.

FIG. 17 is a block diagram of an example software distribution platform (e.g., one or more servers) to distribute software (e.g., software corresponding to the example machine readable instructions of FIGS. 8-13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

Federated learning seeks to address privacy concerns as well as concerns with moving relatively large, localized datasets to a central location. At least some disclosed federated learning techniques include enabling devices (e.g., electronic or computing devices) to train an Artificial Intelligence/Machine Learning (AI/ML) model locally at a node using data observed by the node, and sending the new AI/ML model weights (e.g., weights of a neural network model) to a central location. In some examples, the weights can be sent alone (e.g., without the underlying training data) for enhanced privacy. In some examples, the central location receiving the weights from the node can integrate the weights into a larger or different AI/ML model, and distribute the larger or different AI/ML model to other nodes.

Some such federated learning techniques may be sufficient for some applications, such as personal navigation using maps. However, with other applications, such as medical, retail, or industrial applications, some such federated learning techniques may be deficient and omit context (or contextual) data associated with node(s) that are executing the AI/ML learning/inference operations. For example, some such federated learning techniques do not augment observed data using node information. In some examples, a node may update its local AI/ML model blindly using data from a different node that is observing vastly different behaviors, conditions, events, etc. As a result, the node may perform constant retraining if an environment includes a plurality of nodes with different node information, which can lead to relatively large and/or complex AI/ML models stored at one or more different ones of the nodes. For example, as an AI/ML model stored by a node increases in complexity, the corresponding size of the AI/ML model increases, which can make inference operations more costly with respect to resources (e.g., increase in utilization and/or quantity of hardware, software, and/or firmware resources) and execution time (e.g., increase in execution time).

By way of example, if a first local node in an industrial environment is communicatively coupled to a sensor such as a camera, and the first local node generates labels (e.g., AI/ML labels, AI/ML model output labels, etc.) indicative of defects in the industrial environment, then the newly generated weights (e.g., AI/ML model weights) by the first local node may not be applicable consistently across other local nodes in the industrial environment. For example, a second local node in the industrial environment may retrain its local AI/ML model using data obtained by the first local node. If the data is from a local video stream, such as the camera in communication with the first local node, then physical conditions (e.g., humidity, light, temperature, wind, etc.) may not be the same at the first local node and the second local node. Thus, the second local node may retrain its AI/ML model using labels that may not be applicable to data that the second local node observes. For example, the first local node may be close to a window or be in an area of bright light conditions, while the second local node experiences and/or otherwise observes low light conditions. Existing federated learning techniques do not consider variabilities in an environment, such as physical environment variances, effects of environment on sensor performance, device type or sensor differences, sensor degradation over time, different performance due to age, etc., and/or any combination(s) thereof.

Examples disclosed herein include clustered federated learning using context data. In some disclosed examples, at least some federated learning techniques include enabling multiple nodes to train a deep learning network based on data (e.g., measured data, observed data, live data, sensor data, etc.) observed by the nodes. In some disclosed examples, the at least some federated learning techniques include sending new and/or updated deep learning network weights to a central location or other node(s) in an environment instead of sending the data (e.g., measured data, observed data, live data, sensor data, etc.) itself. For example, the at least some federated learning techniques may determine new weights based on sensor data measured and/or observed at a node; store the sensor data at the node; and transmit the new weights to a server. In some examples, the at least some federated learning techniques may determine new weights based on training data stored, generated, measured, and/or observed at a node; store the training data at the node; and transmit the new weights to a server. Advantageously, at least some example federated learning techniques disclosed herein preserve isolation of data observed by nodes to the nodes that observed the data.

In some disclosed examples, a node can use labeled data observed by the node to update an AI/ML model associated with the node. By way of example, assume a node is communicatively coupled to a sensor, such as a video camera, in an industrial environment, such as a factory. A user associated with the node can detect a defect that was not detected by the AI/ML model. The user can provide input (e.g., a data input) to the node to inform the node that the defect was not detected by the AI/ML model. The node can generate a label (e.g., an AI/ML label or annotation to indicate that a defect is detected) and assign the label to sensor data, such as video data captured by the video camera during a time period in which the defect occurred. For example, the label can define, describe, and/or otherwise explain a conclusion or meaning of the sensor data.

In some disclosed examples, the node can share new or updated weights of the AI/ML model (e.g., new or updated weights that are generated based on the label), and/or, more generally, the updated AI/ML model, with a central location (e.g., a server, a central server, etc.). The central location can include and/or otherwise integrate the new or updated weights into a previously trained AI/ML model. For example, the central location can integrate the new or updated weights by averaging previous weights and the new or updated weights, adopting the updated AI/ML model including the averages of the weights, and/or any other integration technique.

In some disclosed examples, the node can provide context data associated with the new/updated weights to the central location. As used herein, the terms “context data” and “contextual data” are interchangeable and refer to information (e.g., data, metadata, etc.) associated with at least one of a node, an environment or system of the node, or conditions (e.g., circumstances, instances, situations, etc.) present at the node (or associated node(s)) when data (e.g., live data, measured data, sensor data, observed data, etc.) is observed and/or generated at the node. For example, the node can provide context data that includes data or information associated with the node. In some examples, the context data can include the data (e.g., live data, measured data, sensor data, observed data, etc.) that is observed and/or generated at the node. For example, the context data can include observed data at a node, derived data from the observed data, etc.

Examples of context data can include a device type of a device associated with the node, a physical location of the node, a type of sensor associated with the node, environmental data associated with the node, hardware information associated with the node, software information associated with the node, performance and/or age information associated with a sensor and/or hardware and/or software at the node, etc., and/or any combination(s) thereof. Advantageously, by expanding the data provided to the central location, improvements to conventional federated learning techniques can be achieved. For example, the node and/or the central location can reduce complexity of AI/ML models while achieving increased accuracy. Increased accuracy is achieved, for example, by using new or updated weight values determined (e.g., iteratively determined, recursively determined, etc.) using live data, sensor data, training data, etc., associated with one or more nodes. Complexity is reduced, for example, by enabling a node to execute and/or train (e.g., retrain) a portion of a larger AI/ML model instead of an entirety of the larger AI/ML model. By executing and/or training (e.g., retraining) a portion of the larger AI/ML model, less resources (e.g., compute, storage, network, security, acceleration, etc., resources) may be utilized to effectuate the executing and/or the training (e.g., the retraining). In some examples, the central location can cluster nodes of an environment that are similar to each other with respect to their context data. Advantageously, at least some example federated learning techniques disclosed herein can include providing a subset or a portion of an AI/ML model to be deployed on resource constrained nodes to increase AI/ML learning/inference capabilities of the resource constrained nodes while minimizing and/or otherwise reducing the hardware, software, and/or firmware utilization of the resource constrained nodes.

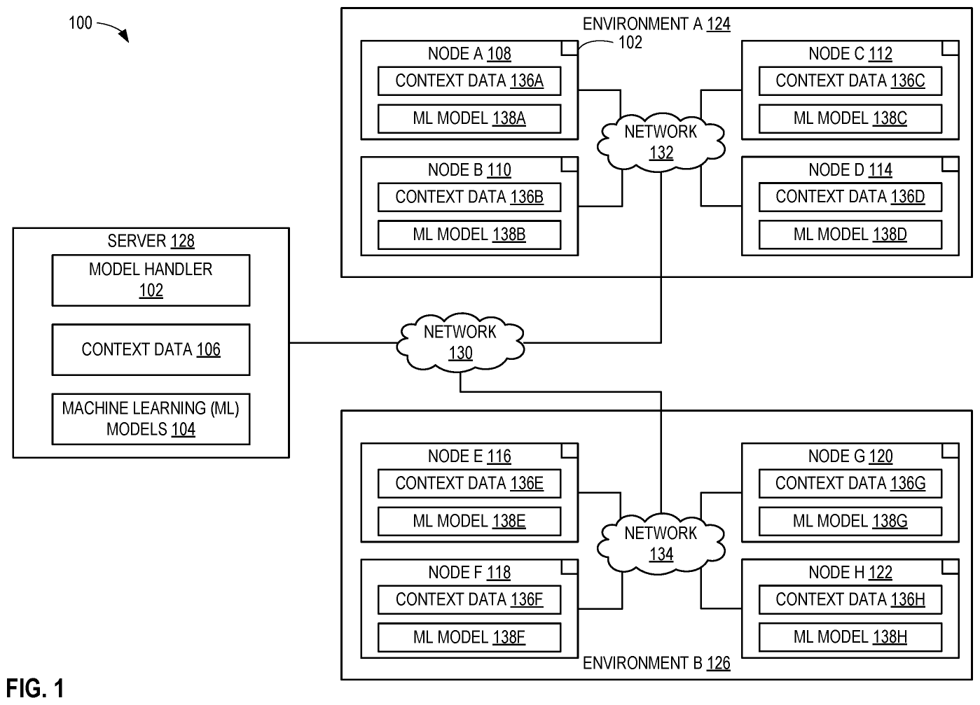

FIG. 1 is an illustration of an example federated learning system 100, which includes an example model handler 102. In some examples, the model handler 102, and/or, more generally, the federated learning system 100, can improve training of example machine learning (ML) models 104 based on example context data 106 associated with example nodes 108, 110, 112, 114, 116, 118, 120, 122 of example environments 124, 126. In the illustrated example, an example server (e.g., a computer or electronic server, an edge server, a cloud server, etc.) 128 is in communication with ones of the nodes 108, 110, 112, 114, 116, 118, 120, 122 via example networks 130, 132, 134. In the illustrated example, the networks 130, 132, 134 include a first example network 130, a second example network 132, and a third example network 134. Alternatively, there may be fewer or more environments, nodes, networks, and/or servers than depicted in the illustrated example of FIG. 1.

In some examples, the environments 124, 126 are representative of physical environments, such as commercial, industrial, public, and/or residential environments. For example, one(s) of the environments 124, 126 can be a commercial environment such as a bar and/or nightclub, a hospital, a movie theatre, a restaurant, a retail store, etc., and/or any combination(s) thereof. In some examples, one(s) of the environments 124, 126 can be an industrial environment, such as an airport, a factory, a refinery (e.g., a process control environment), a shipyard, a warehouse, etc., and/or any combination(s) thereof. In some examples, one(s) of the environments 124, 126 can be a public environment such as a government building or office, a museum, a park, a zoo, etc., and/or any combination(s) thereof. In some examples, one(s) of the environments 124, 126 can be a residential environment such as an apartment building, a condominium building or complex, a neighborhood subdivision, etc., and/or any combination(s) thereof. In some examples, one(s) of the environments 124, 126 can be combination(s) of physical environments. Additionally and/or alternatively, one(s) of the environments 124, 126 may be representative of virtual environments, such as computer networks, computing environments (e.g., cloud and/or edge computing environments), etc., and/or any combination(s) thereof. In some examples, one(s) of the environments 124, 126 can be combination(s) of physical and/or virtual environments.

In some examples, one(s) of the nodes 108, 110, 112, 114, 116, 118, 120, 122 are logical entities representative of hardware, software, and/or firmware. For example, one(s) of the nodes 108, 110, 112, 114, 116, 118, 120, 122 can be implemented using hardware (e.g., processor circuitry, memory, interface circuitry, accelerators, etc.), software (e.g., driver(s), an operating system (OS), application programming interface(s) (API(s)), etc.), and/or firmware.

In some examples, one(s) of the nodes 108, 110, 112, 114, 116, 118, 120, 122 are physical devices. For example, one(s) of the nodes 108, 110, 112, 114, 116, 118, 120, 122 can be a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a headset (e.g., an augmented reality (AR) headset, a virtual reality (VR) headset, etc.) or other wearable device, or any other type of computing or electronic device. In some examples, one(s) of the nodes 108, 110, 112, 114, 116, 118, 120, 122 can be a sensor (e.g., an electronic device capable of generating analog measurements and converting the analog measurements data into digital data). For example, one(s) of the nodes 108, 110, 112, 114, 116, 118, 120, 122 can be a sensor such as an antenna, a camera (e.g., a still-image camera, a video camera, an infrared camera, etc.), a laser (e.g., a light detection and ranging (LIDAR) sensor), a radiofrequency identification (RFID) reader, an environment sensor (e.g., a humidity sensor, a light sensor, a temperature sensor, a wind sensor, etc.), etc., or any other type of sensor. In some examples, one(s) of the nodes 108, 110, 112, 114, 116, 118, 120, 122 are logical entities representative of hardware, software, and/or firmware that are in communication with sensor(s). For example, a first one of the nodes 108, 110, 112, 114, 116, 118, 120, 122 can be an edge server, a network interface, etc., that receives data from a sensor, such as a video camera.

In the illustrated example, a first example environment 124 (identified by ENVIRONMENT A) of the environments 124, 126 includes a first example node 108 (identified by NODE A), a second example node 110 (identified by NODE B), a third example node 112 (identified by NODE C), and a fourth example node 114 (identified by NODE D). The first node 108 includes the model handler 102 (e.g., an instance or portion(s) of the model handler 102), first example node context data 136A, and a first example ML model 138A. The second node 110 includes the model handler 102 (e.g., an instance or portion(s) of the model handler 102), second example node context data 136B, and a second example ML model 138B. The third node 112 includes the model handler 102 (e.g., an instance or portion(s) of the model handler 102), third example node context data 136C, and a third example ML model 138C. The fourth node 114 includes the model handler 102 (e.g., an instance or portion(s) of the model handler 102), fourth example node context data 136D, and a fourth example ML model 138D.

In the illustrated example, a second example environment 126 (identified by ENVIRONMENT B) of the environments 124, 126 includes a fifth example node 116 (identified by NODE E), a sixth example node 118 (identified by NODE F), a seventh example node 120 (identified by NODE G), and an eighth example node 122 (identified by NODE H). The fifth node 116 includes the model handler 102 (e.g., an instance or portion(s) of the model handler 102), fifth example node context data 136E, and a fifth example ML model 138E. The sixth node 118 includes the model handler 102 (e.g., an instance or portion(s) of the model handler 102), sixth example node context data 136F, and a sixth example ML model 138F. The seventh node 120 includes the model handler 102 (e.g., an instance or portion(s) of the model handler 102), seventh example node context data 136G, and a seventh example ML model 138G. The eighth node 122 includes the model handler 102 (e.g., an instance or portion(s) of the model handler 102), eighth example node context data 136H, and an eighth example ML model 138H.

The first through fourth nodes 108, 110, 112, 114 are connected to one(s) of each other via the second network 132. The first through fourth nodes 108, 110, 112, 114 are connected to the server 128 by way of the second network 132 and the first network 130. In some examples, the first through fourth nodes 108, 110, 112, 114 are connected to one(s) of the fifth through eighth nodes 116, 118, 120, 122 in the second environment 126 via the second network 132 and the third network 134. The fifth through eighth nodes 116, 118, 120, 122 are connected to one(s) of each other via the third network 134. The fifth through eighth nodes 116, 118, 120, 122 are connected to the server 128 by way of the third network 134 and the first network 130.

The networks 130, 132, 134 of the illustrated example of FIG. 1 are the Internet. However, the first network 130, the second network 132, and/or the third network 134 may be implemented using any suitable wired and/or wireless network(s) including, for example, one or more data buses, one or more Local Area Networks (LANs), one or more wireless LANs (WLANs), one or more cellular networks, one or more satellite networks, one or more private networks, one or more public networks, etc., and/or any combination(s) thereof.

The server 128 of the illustrated example includes the model handler 102 (e.g., an instance or portion(s) of the model handler 102), the ML models 104, and the context data 106. In some examples, the ML models 104 include one(s) of the ML models 138A, 138B, 138C, 138D, 138E, 138F, 138G, 138H. For example, the ML models 104 can include a first ML model, and one(s) of the ML models 138A, 138B, 138C, 138D of the first through fourth nodes 108, 110, 112, 114 can be portion(s) of the first ML model. In some examples, the ML models 104 can include a second ML model, and one(s) of the ML models 138E, 138F, 138G, 138H of the fifth through eighth nodes 116, 118, 120, 122 can be portion(s) of the second ML model. In some examples, the ML models 104 can include a third ML model, and one(s) of the ML models 138A, 138B, 138C, 138D of the first through fourth nodes 108, 110, 112, 114 and/or one(s) of the ML models 138E, 138F, 138G, 138H of the fifth through eighth nodes 116, 118, 120, 122 can be portion(s) of the third ML model.

In some examples, the context data 106 of the server 128 includes one(s) of the first node context data 136A, the second node context data 136B, the third node context data 136C, the fourth node context data 136D, the fifth node context data 136E, the sixth node context data 136F, the seventh node context data 136G, and/or the eighth node context data 136H. For example, the first node 108 can provide the first node context data 136A to the server 128.

In some examples, the context data 106, 136A-136H corresponds to data associated with a node. For example, the context data 106, 136A-136H can include at least one of a device type of a node, a physical location of the node, a type of sensor associated with the node, environmental data associated with the node, hardware information associated with the node, or software information associated with the node. For example, the first node context data 136A, and/or, more generally, the context data 106 of the server 128, can include at least one of a device type of the first node 108, a physical location of the first node 108, a type of sensor associated with the first node 108, environmental data associated with the first node 108, hardware information associated with the first node 108, or software information associated with the first node 108.

By way of example, assume that the first node 108 is a video camera system including processor circuitry communicatively coupled to a video camera. In such an example, the first node context data 136A can include a device type such as a video camera, and/or, more generally, a video camera system. The first node context data 136A can include a physical location of the video camera, such as the first environment 124, a location or position within the first environment 124 (e.g., an area, grid, sector, etc.), a height or altitude of the video camera, etc., and/or any combination(s) thereof. The first node context data 136A can include a type of sensor of the video camera system, such as an image sensor, a light sensor, a motion sensor, etc., and/or any combination(s) thereof. The first node context data 136A can include sensor description data, which can include data associated with a quality and/or nature of sensor data. For example, the sensor description data can include a number of pixels in video data captured by the video camera system, a brightness of the video data, an intensity of the video data, color data of the pixels of the video data, a video data format of the video data, etc., and/or any combination(s) thereof. The first node context data 136A can include environmental data associated with the video camera system, such as lighting conditions (e.g., low light conditions, bright light conditions, etc.), an ambient temperature of the video camera system, etc., and/or any combination(s) thereof. The first node context data 136A can include hardware information associated with the video camera system, such as a make and/or model of the processor circuitry, technical specifications of the processor circuitry (e.g., a quantity of gigahertz (GHz) of compute power, a clock speed, a quantity of cache memory, a Basic Input/Output System (BIOS) version, etc.), a make and/or model of the video camera, a precision associated with operation of the video camera, technical specifications of the video camera (e.g., a video output resolution, a frame rate, a recording limit, quantity of onboard memory or mass storage, audio or microphone specifications, etc.), etc., and/or any combination(s) thereof. The first node context data 136A can include software and/or firmware information associated with the video camera system, such as a type and/or version of an OS instantiated by the processor circuitry, a version of a driver instantiated by the processor circuitry, etc., and/or any combination(s) thereof.

In example operation, the server 128 and/or the nodes 108, 110, 112, 114, 116, 118, 120, 122 effectuate example federated learning techniques to achieve improved AI/ML training and/or inference operations associated with AI/ML workloads (e.g., AI/ML compute or computing, electronic, etc., workloads). For example, the model handler 102 of the server 128 can instantiate one(s) of the ML models 104 based on the context data 106. In some examples, the model handler 102 of the server 128 can distribute portion(s) of the ML models 104 to corresponding ones of the nodes 108, 110, 112, 114, 116, 118, 120, 122. For example, the model handler 102 of the server 128 can generate a first ML model of the ML models 104 based on the first node context data 136A and the second node context data 136B. In some examples, the model handler 102 of the server 128 can distribute and/or otherwise deploy (i) a first portion, subset, etc., of the first ML model to the first node 108 based on the first portion, subset, etc., corresponding to the first node context data 136A and (ii) a second portion, subset, etc., of the first ML model to the second node 110 based on the second portion, subset, etc., corresponding to the second node context data 136B.

In example operation, the nodes 108, 110, 112, 114, 116, 118, 120, 122 can obtain data (e.g., sensor data) and provide the data as model inputs to the ML models 138A-138H to cause the ML models 138A-138H to generate model outputs. By way of example, the first node 108 can obtain and/or capture sensor data such as video data from a video camera associated with the first node 108. For example, the video data can include images of products, goods, etc., being assembled on a factory assembly production line. The first node 108 can provide the sensor data as model input(s) to the first ML model 138A. The first ML model 138A can execute inference operations on the sensor data to produce and/or otherwise output model outputs, which can include a decision, a determination, a recommendation, etc., to carry out an action, operation, etc., in connection with the first node 108, and/or, more generally, the first environment 124.

In example operation, a user associated with the first node 108, such as factory supervisor, can identify a defect with a product that is assembled in the first environment 124 (e.g., a product being assembled on a factory assembly production line). The user can determine that the defect was not detected by the first node 108 (e.g., the first ML model 138A did not generate a model output indicative of the defect based on ingested video data). The user can provide commands, data inputs, feedback, instructions, etc., representative of the missed defect detection to the first node 108. In response to receiving the feedback from the user, the first node 108 can generate a label and associate the label with the video data. For example, the first node 108 can generate one or more labels of “alarm,” “alert,” “defect,” “error,” or the like and the first node 108 can assign the one or more labels to video data associated with the defect during a time period in which the defect is identified to have occurred.

In example operation, the first node 108 can train (e.g., retrain) the first ML model 138A based on the label(s). For example, the first node 108 can invoke the first ML model 138A to carry out retraining operations to determine, generate, and/or otherwise output new, revised, or updated weights (e.g., ML weights, neural network weights, etc.) of the first ML model 138A. For example, the first node 108 can invoke execution of the first ML model 138A to output weights of the first ML model 138A. Advantageously, the first node 108 can retrain the first ML model 138A to identify similar defects in future operations of the first environment 124 and thereby increase an accuracy of the first ML model 138A.

In example operation, the first node 108 can provide the new/revised/updated weights and/or the first node context data 136A to the model handler 102 of the server 128 to effectuate example federated learning techniques as described herein. In some examples, the model handler 102 of the server 128 can identify portion(s) of the ML models 104 of which to retrain using the new/revised/updated weights. For example, the model handler 102 of the server 128 can identify a first portion of a first one of the ML models 104 that corresponds to the first node context data 136A. In some examples, in response to the model handler 102 of the server 128 retraining the first portion, the model handler 102 can distribute and/or otherwise deploy the first portion, and/or, more generally, the first one of the ML models 104, to one(s) of the nodes 108, 110, 112, 114, 116, 118, 120, 122 that correspond(s) to the first node context data 136A. For example, the model handler 102 of the server 128 can identify that the second node 110 corresponds to the first node context data 136A based on a determination that the first node context data 136A and the second node context data 136B include the same (or substantially similar) device type (e.g., a video camera), location, etc. Advantageously, the model handler 102 of the server 128 can deploy the retrained first portion of the first one of the ML models 104 to the first node 108 and the second node 110 based on a determination that the first node 108 and the second node 110 are associated with each other based on their respective context data.

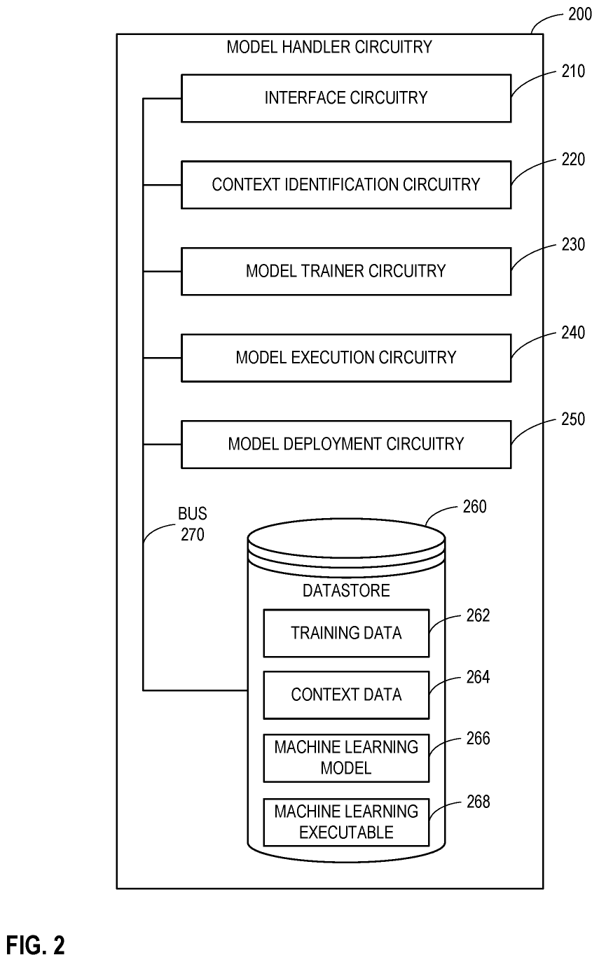

FIG. 2 is a block diagram of an example implementation of model handler circuitry 200. In some examples, the model handler circuitry 200 can improve federated learning of AI and/or ML (AI/ML) nodes. The model handler circuitry 200 of FIG. 2 may be instantiated by processor circuitry such as a central processing unit executing instructions. For example, the model handler 102 of FIG. 1 can be instantiated by the model handler circuitry 200. As used herein, “instantiating” is defined to mean creating an instance of, bring into being for any length of time, materialize, implement, etc. For example, the model handler circuitry 200 can instantiate the model handler 102 by implementing the model handler 102. In some examples, the model handler circuitry 200 can instantiate the model handler 102 by executing machine readable instructions. Additionally or alternatively, the model handler circuitry 200 of FIG. 2 may be instantiated by an ASIC or an FPGA structured to perform operations corresponding to the instructions. It should be understood that some or all of the model handler circuitry 200 of FIG. 2 may, thus, be instantiated at the same or different times. Some or all of the model handler circuitry 200 may be instantiated, for example, in one or more threads executing partially or completely concurrently on hardware and/or in series on hardware. Moreover, in some examples, some or all of the model handler circuitry 200 of FIG. 2 may be implemented by one or more virtual machines and/or containers executing on the microprocessor.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model handler 102 and/or the model handler circuitry 200 can train the ML models 104, the ML models 138A-138H, and/or an example ML model 266 with data to recognize patterns and/or associations and follow such patterns and/or associations when processing input data such that other input(s) result in output(s) consistent with the recognized patterns and/or associations. In some examples, the ML model 266 can correspond to one(s) of the ML models 104, the first ML model 138A, the second ML model 138B, the third ML model 138C, the fourth ML model 138D, the fifth ML model 138E, the sixth ML model 138F, the seventh ML model 138G, and/or the eighth ML model 138H of FIG. 1.

Many different types of machine-learning models and/or machine-learning architectures exist. In some examples, the model handler circuitry 200 generates the machine learning model 266 as a neural network model. Using a neural network model enables the nodes 108, 110, 112, 114, 116, 118, 120, 122 to execute an AI/ML workload. In general, machine-learning models/architectures that are suitable to use in the example approaches disclosed herein include recurrent neural networks. However, other types of machine learning models could additionally or alternatively be used such as supervised learning ANN models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine or network, Naive Bayes, etc. In some examples, the model handler circuitry 200 may compile and/or otherwise generate the ML model 266 as a lightweight machine learning model.

In general, implementing an AI/ML system involves two phases, a learning/training phase and an inference phase. In the learning/training phase, a training algorithm is used to train the ML model 266 to operate in accordance with patterns and/or associations based on, for example, training data. In general, the ML model 266 includes internal parameters that guide how input data is transformed into output data, such as through a series of nodes and connections within the ML model 266 to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of AI/ML model and/or the expected output. For example, the model handler circuitry 200 may invoke supervised training to use inputs and corresponding expected (e.g., labeled) outputs to select parameters (e.g., by iterating over combinations of select parameters) for the ML model 266 that reduce model error. As used herein, “labeling” refers to an expected output of the machine learning model (e.g., a classification, an expected output value, etc.). Alternatively, the model handler circuitry 200 may invoke unsupervised training (e.g., used in deep learning, a subset of machine learning, etc.) that involves inferring patterns from inputs to select parameters for the ML model 266 (e.g., without the benefit of expected (e.g., labeled) outputs).

In some examples, the model handler circuitry 200 trains the ML model 266 using unsupervised clustering of operating observables. For example, the operating observables may include context data (e.g., the context data 106, the context data 138A-138H, example context data 264, etc.), environment data (e.g., data associated with the first environment 124 and/or the second environment 126), sensor data, etc., and/or any combination(s) thereof. However, the model handler circuitry 200 may additionally or alternatively use any other training algorithm such as stochastic gradient descent, Simulated Annealing, Particle Swarm Optimization, Evolution Algorithms, Genetic Algorithms, Nonlinear Conjugate Gradient, etc.

In some examples, the model handler circuitry 200 may train the ML model 266 until the level of error is no longer reducing. In some examples, the model handler circuitry 200 may train the ML model 266 locally on the nodes 108, 110, 112, 114, 116, 118, 120, 122 and/or remotely at an external computing system (e.g., the server 128) communicatively coupled to the nodes 108, 110, 112, 114, 116, 118, 120, 122. In some examples, the model handler circuitry 200 trains the ML model 266 using hyperparameters that control how the learning is performed (e.g., a learning rate, a number of layers to be used in the machine learning model, etc.). In some examples, the model handler circuitry 200 may use hyperparameters that control model performance and training speed such as the learning rate and regularization parameter(s). The model handler circuitry 200 may select such hyperparameters by, for example, trial and error to reach an optimal model performance. In some examples, the model handler circuitry 200 utilizes Bayesian hyperparameter optimization to determine an optimal and/or otherwise improved or more efficient network architecture to avoid model overfitting and improve the overall applicability of the ML model 266. Alternatively, the model handler circuitry 200 may use any other type of optimization. In some examples, the model handler circuitry 200 may perform re-training. The model handler circuitry 200 may execute such re-training in response to override(s) by a user of the nodes 108, 110, 112, 114, 116, 118, 120, 122, the server 128, a receipt of new training data, etc.

In some examples, the model handler circuitry 200 facilitates the training of the ML model 266 using example training data 262. In some examples, the model handler circuitry 200 utilizes the training data 262 that originates from locally generated data, such as labels, sensor data, etc. In some examples, the model handler circuitry 200 utilizes the training data 262 that originates from externally generated data, such as labels, sensor data, etc., associated with a different environment. In some examples where supervised training is used, the model handler circuitry 200 may label the training data 262 (e.g., label the training data 262 or portion(s) thereof as a defect, an object detection, an alarm or alert, etc.). Labeling is applied to the training data 262 by a user manually or by an automated data pre-processing system. In some examples, the model handler circuitry 200 may pre-process the training data 262 using, for example, an interface (e.g., example interface circuitry 210) to extract sensor data of interest. In some examples, the model handler circuitry 200 sub-divides the training data 262 into a first portion of data for training the ML model 266, and a second portion of data for validating the ML model 266.

Once training is complete, the model handler circuitry 200 may deploy the ML model 266 for use as an executable construct that processes an input and provides an output based on the network of nodes and connections defined in the ML model 266. For example, the model handler circuitry 200 can generate an example machine learning (ML) executable 268 based on the ML model 266. The model handler circuitry 200 may store the ML model 266 and the ML executable 268 in an example datastore 260. In some examples, the model handler circuitry 200 may invoke the interface circuitry 210 to transmit the ML model 266, the ML executable 268, etc., to one(s) of the nodes 108, 110, 112, 114, 116, 118, 120, 122. In some examples, in response to transmitting the ML model 266, the ML executable 268, etc., to the one(s) of the nodes 108, 110, 112, 114, 116, 118, 120, 122, the one(s) of the nodes 108, 110, 112, 114, 116, 118, 120, 122 may execute the ML model 266, the ML executable 268, etc., to execute AI/ML workloads with at least one of improved efficiency or performance.

Once trained, the deployed ML model 266, the ML executable 268, etc., may be operated in an inference phase to process data. In the inference phase, data to be analyzed (e.g., live data) is input to the ML model 266, the ML executable, etc., and the ML model 266, the ML executable 268, etc., execute(s) to create an output. This inference phase can be thought of as the AI “thinking” to generate the output based on what it learned from the training (e.g., by executing the ML model 266, the ML executable 268, etc., to apply the learned patterns and/or associations to the live data). In some examples, input data undergoes pre-processing before being used as an input to the ML model 266, the ML executable 268, etc. Moreover, in some examples, the output data may undergo post-processing after it is generated by the ML model 266, the ML executable 268, etc., to transform the output into a useful result (e.g., a display of data, a detection and/or identification of an object, an instruction to be executed by a machine, etc.).

In some examples, output(s) of the deployed ML model 266, the ML executable 268, etc., may be captured and provided as feedback. By analyzing the feedback, an accuracy of the deployed ML model 266, the ML executable 268, etc., can be determined. If the feedback indicates that the accuracy of the deployed model is less than a threshold or other criterion, training of an updated model can be triggered using the feedback and an updated training data set, hyperparameters, etc., to generate an updated, deployed model. As used herein, a “new model” may refer to an ML model that has a different graph (e.g., an ML graph, a neural network graph, etc.) from a previous ML model. For example, a first ML model can have a first graph and a new ML model can have a second graph different from the first graph. As used herein, “a revised model” or an “updated model” are interchangeable and may refer to a version of an ML model that has the same structure (e.g., the same graph) as a previous version of the ML model but with revised or updated weights. For example, a first ML model can have a first graph and first weight. In some examples, an updated version of the first ML model can have the first graph, but one or more of the first weights can be revised or updated from one or more first values to one or more second values.

The model handler circuitry 200 of the illustrated example includes the example interface circuitry 210, example context identification circuitry 220, example model trainer circuitry 230, example model execution circuitry 240, example model deployment circuitry 250, an example datastore 260, and an example bus 270. In this example, the datastore 260 includes the example training data 262, the example context data 264, the example machine learning model 266, and the example machine learning executable 268. In the illustrated example, one(s) of the interface circuitry 210, the context identification circuitry 220, the model trainer circuitry 230, the model execution circuitry 240, the model deployment circuitry 250, and/or the datastore 260 are in communication with one(s) of each other via the bus 270. For example, the bus 270 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 270 can be implemented by any other type of computing or electrical bus.

In the illustrated example of FIG. 2, the model handler circuitry 200 includes the interface circuitry 210 to receive and/or transmit data. In some examples, the interface circuitry 210 receives and/or otherwise obtains an indication from a first node to retrain a machine learning model. For example, the interface circuitry 210 can receive data from the first node 108 that is indicative of and/or otherwise representative of a request for retraining of the first ML model 138A. In some examples, the data can be generated by the first node 108 in response to a detection of a defect not identified by the first ML model 138A, an event not accurately predicted by the first ML model 138A, etc. For example, a user associated with the first node 108 can generate the data by entering data inputs into a user interface (UI). In some examples, the interface circuitry 210 obtains label(s) associated with event(s) observed by a node. For example, the first node 108 can generate the data to include label(s) corresponding to the defect detection, the non-predicted event, etc.

In some examples, the interface circuitry 210 transmits context data and weights to a remote node. For example, the interface circuitry 210 can transmit the first node context data 136A to the server 128. In some examples, the interface circuitry 210 can transmit AI/ML weights generated at the first node 108 to the server 128. In some examples, the interface circuitry 210 transmits weights to node(s) of an environment corresponding to context data. For example, the interface circuitry 210 can transmit weights generated at the server 128 to one(s) of the nodes 108, 110, 112, 114, 116, 118, 120, 122 that correspond to portion(s) of the context data 106 associated with the weights.

In some examples, the interface circuitry 210 obtains weights for portion(s) of a machine learning model associated with an environment from a node. For example, the interface circuitry 210 can receive weights for portion(s) of the ML models 104 from the server 128. In some examples, the interface circuitry 210 determines whether to continue monitoring an environment. For example, the interface circuitry 210 can determine whether to continue monitoring for new data ingested at the first node 108, and/or, more generally, the first environment 124. In some examples, the interface circuitry 210 can determine whether to continue monitoring for new data received at the server 128 that is obtained from one(s) of the nodes 108, 110, 112, 114, 116, 118, 120, 122.

In the illustrated example of FIG. 2, the model handler circuitry 200 includes the context identification circuitry 220 to determine context data associated with a node based on an identifier of the node. For example, the context identification circuitry 220 can receive data from the first node 108. In some examples, the data includes an identifier that identifies the first node 108. For example, the identifier can be an Internet Protocol (IP) address, a media access control (MAC) address, a universally unique identifier (UUID), or any other type of data that may be used for identification purposes. The context identification circuitry 220 can map the identifier to portion(s) of the context data 106 that corresponds to the first node 108. The context identification circuitry 220 can identify information associated with the first node 108 based on the mapping of the identifier to the portion(s) of the context data 106 that corresponds to the first node.

In the illustrated example of FIG. 2, the model handler circuitry 200 includes the model trainer circuitry 230 to train and/or retrain a machine learning model based on context data. In some examples, the model trainer circuitry 230 instantiates a machine learning model for nodes associated with an environment. For example, the model trainer circuitry 230 can instantiate the first ML model 138A based on the first node context data 136A. In some examples, the model trainer circuitry 230 can instantiate the first ML model 138A by initializing an AI/ML model and training the AI/ML model based on training data and/or the first node context data 136A to output a trained AI/ML model.

In some examples, the model trainer circuitry 230 clusters portions of a machine learning model into respective groups based on context data associated with nodes. For example, the model trainer circuitry 230 can identify a first ML model of the ML models 104 that includes a first portion corresponding to the first node 108 and a second portion corresponding to the second node 110. In some examples, the model trainer circuitry 230 can cluster the first portion and the second portion into a group in response to a determination that the first node context data 136A is associated with the second node context data 136B (e.g., a first location indicated by the first node context data 136A is related to and/or comparable to a second location indicated by the second node context data 136B). In some examples, the model trainer circuitry 230 determines weights for portions of a machine learning model based on training data. For example, the model trainer circuitry 230 can determine first weights for the first portion and second weights for the second portion based on training data.

In some examples, the model trainer circuitry 230 determines whether to retrain a machine learning model at a local node or a remote node. For example, the model trainer circuitry 230 can determine to retrain the first ML model 138A at a local node, such as the first node 108 where the first ML model 138A is to be deployed. In some examples, the model trainer circuitry 230 can obtain context data associated with the local node, such as the first node 108. In some examples, the model trainer circuitry 230 can obtain label(s) corresponding to event(s) observed by the local node. For example, the model trainer circuitry 230 can obtain a label generated by a user. In some examples, the model trainer circuitry 230 can generate weights of portion(s) of the machine learning model associated with the local node based on the label(s). For example, the model trainer circuitry 230 can invoke retraining of the first ML model 138A at the first node 108 based on the label. In some examples, the model trainer circuitry 230 can generate new, updated, and/or revised weights of the first ML model 138A based on the retraining of the first ML model 138A using the label.

In some examples, the model trainer circuitry 230 determines that only portion(s) of a machine learning model that is/are associated with context data is/are to be retrained. For example, the model trainer circuitry 230 can determine that multiple portions of the ML models 104 are to be retrained because the multiple portions are associated with similar context data (e.g., the first node context data 136A and the second node context data 136B if they include data, metadata, etc., that are the same and/or relatively similar). In some examples, in response to determining that the multiple portions are to be retrained, the model trainer circuitry 230 can retrain the multiple portions based on obtained label(s). For example, the model trainer circuitry 230 can update weights for the multiple portions that are associated with the context data. In some examples, the model trainer circuitry 230 can update weights for all portions of an ML model. For example, the model trainer circuitry 230 can integrate weights received from the first node 108 into an entire ML model by averaging the previously determined weights with the newly received weights or any other type of weight integration technique.

In some examples, the model trainer circuitry 230 can determine to retrain the first ML model 138A at a remote node, such as the server 128. For example, the model trainer circuitry 230 can provide a label or other type of AI/ML data input to the server 128 to cause the server 128 to retrain a portion of the ML models 104 that corresponds to the first ML model 138A.

In some examples, the model trainer circuitry 230 can determine to instantiate new layer(s) of a machine learning model based on label(s) corresponding to a subset of a machine learning model. For example, the model trainer circuitry 230 can determine that a label associated with an incident captured by the first node 108 is applicable to multiple portions of a first one of the ML models 104. In some examples, the model trainer circuitry 230 can instantiate a new layer in the first one of the ML models 104 that can act as a switch to follow a first branch, cluster, group, etc., of the first one of the ML models 104 or a second branch, cluster, group, etc., of the first one of the ML models 104. For example, the new layer and corresponding weights can be instantiated based on the label, the first node context data 136A (e.g., context data associated with the node that caused the label to be generated, etc.), etc.

In some examples, the model trainer circuitry 230 retrains a portion of a machine learning model based on context data associated with a first node. For example, the model trainer circuitry 230 can receive weights generated by the first node 108 and the first node context data 136A. In some examples, the model trainer circuitry 230 can identify a portion of the ML models 104 to retrain based on a determination that the first node context data 136A corresponds to the portion of the ML models 104.

In the illustrated example of FIG. 2, the model handler circuitry 200 includes the model execution circuitry 240 to generate machine learning output(s) using portion(s) of a machine learning model based on input data associated with one or more environments. In some examples, the model execution circuitry 240 can invoke execution of the first ML model 138A on hardware, such as processor circuitry, an accelerator, a heterogeneous electronic device (e.g., an electronic device including multiple instances and/or types of processor circuitry, accelerators, etc.), etc. For example, the model execution circuitry 240 can provide sensor data ingested by the first node 108 to the first ML model 138A as model inputs to cause the first ML model 138A to generate model outputs. In some examples, the model outputs can be an alarm or alert indicative of a defect, a failure, or other type of imminent event in an industrial environment. In some examples, the model outputs can be a detection of an object (e.g., a person, an animal, a vehicle, etc.) in connection with an autonomous vehicle environment (e.g., a road, a highway, etc.).

In some examples, the model execution circuitry 240 determines whether a machine learning output indicates that a portion of a machine learning model is to be retrained. For example, the model execution circuitry 240 can receive input from a user that a defect or other event occurred in the first environment 124 but was not detected by the first ML model 138A. In some examples, the model execution circuitry 240 can compare the input from the user to model outputs generated by the first ML model 138A to determine whether the first ML model 138A is to be retrained. For example, the model execution circuitry 240 can determine that the first ML model 138A is to be retrained based on the comparison, which can be indicative of a mismatch between user observations and ML model determinations that is to be corrected or improved.

In the illustrated example of FIG. 2, the model handler circuitry 200 includes the model deployment circuitry 250 to deploy a machine learning model or portion(s) thereof to node(s) to execute workload(s) (e.g., AI/ML workloads, compute workloads, networking workloads, etc., and/or any combination(s) thereof). For example, the model deployment circuitry 250 can deploy a first portion of a first one of the ML models 104 to the first node 108 based on the first portion corresponding to the first node context data 136A. In some examples, the first node 108 can instantiate the first portion as the first ML model 138A (e.g., the first ML model 138A is the first portion of the first one of the ML models 104).

In some examples, the model deployment circuitry 250 can update a machine learning model at a local node (e.g., update the first ML model 138A at the first node 108) or a remote node (e.g., update the first ML model 138A at the server 128). In some examples, the model deployment circuitry 250 deploys weights at the local node. For example, in response to generating weights at the first node 108, the model deployment circuitry 250 can update the first ML model 138A using the weights. In some examples, the model deployment circuitry 250 deploys weights from the remote node. For example, the model deployment circuitry 250 can generate weights for the first ML model 138A at the server 128 and transmit the weights from the server 128 to the first node 108 by way of the first network 130 and the second network 132.

In the illustrated example of FIG. 2, the model handler circuitry 200 includes the datastore 260 to record data, such as the training data 262, the context data 264, the machine learning model 266, and the machine learning executable 268. The datastore 260 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 260 may additionally or alternatively be implemented by one or more double data rate (DDR) memories, such as DDR, DDR2, DDR3, DDR4, DDR5, mobile DDR (mDDR), DDR SDRAM, etc. The datastore 260 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the datastore 260 is illustrated as a single database, the datastore 260 may be implemented by any number and/or type(s) of datastores. Furthermore, the data stored in the datastore 260 may be in any data format such as, for example, binary data, comma delimited data, tab delimited data, structured query language (SQL) structures, an executable file, a kernel, etc.

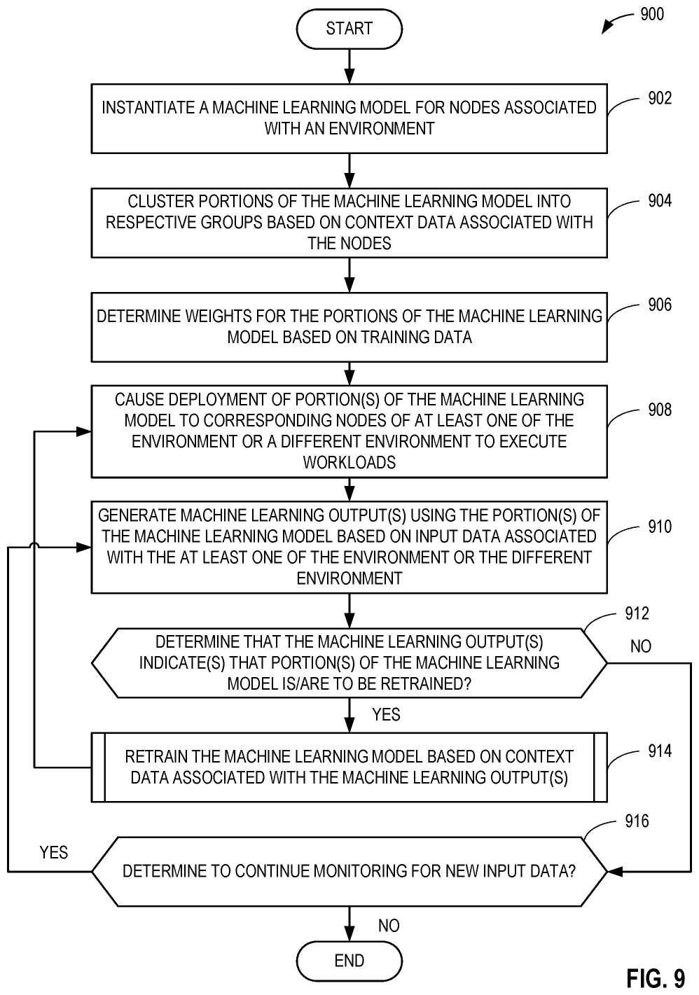

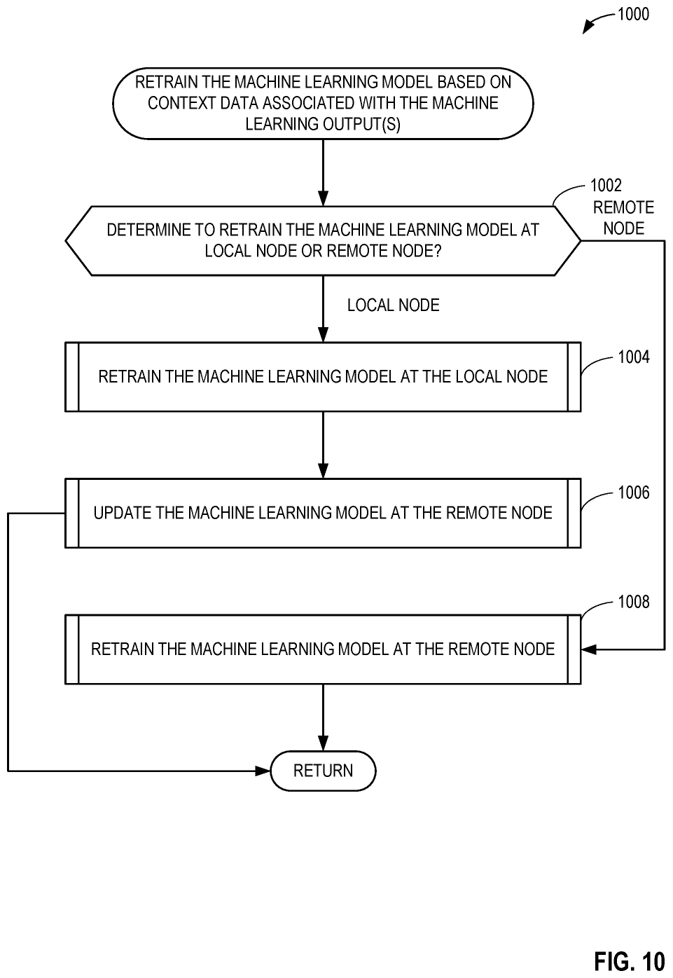

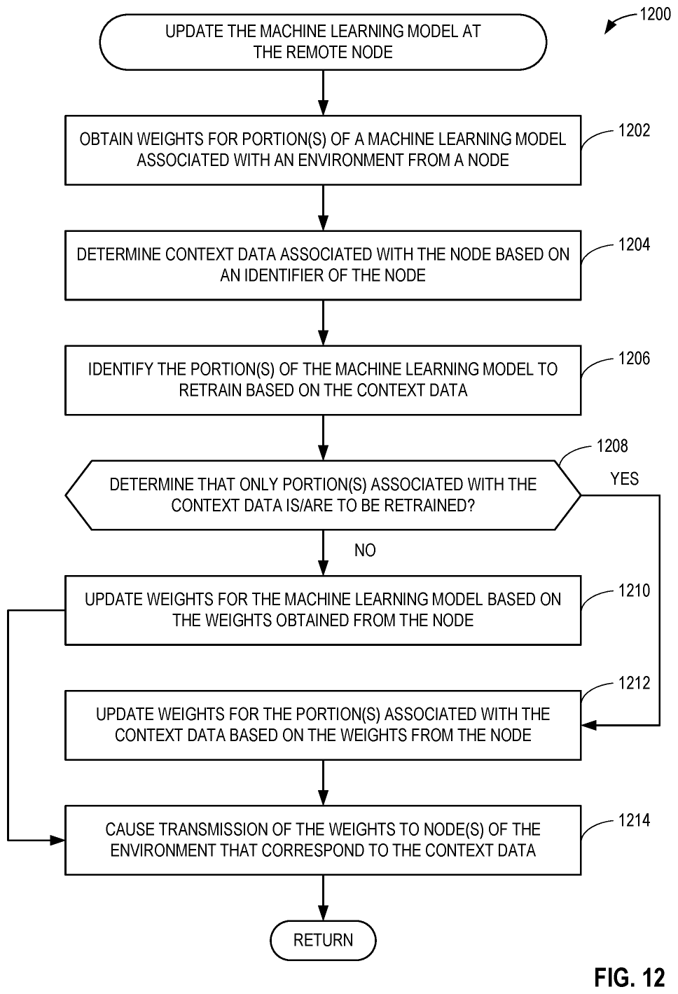

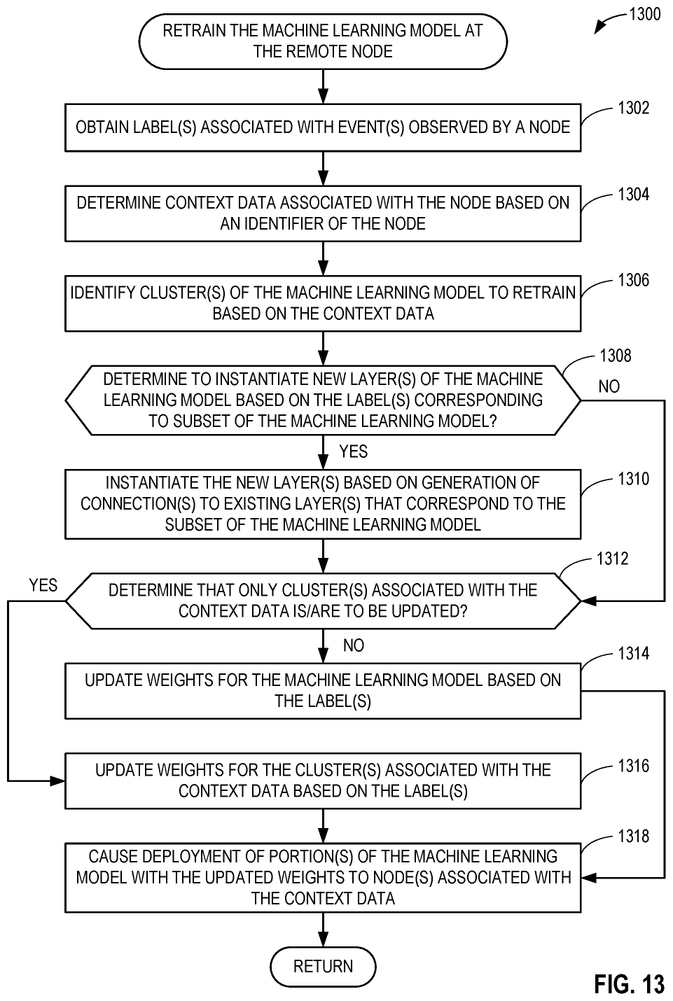

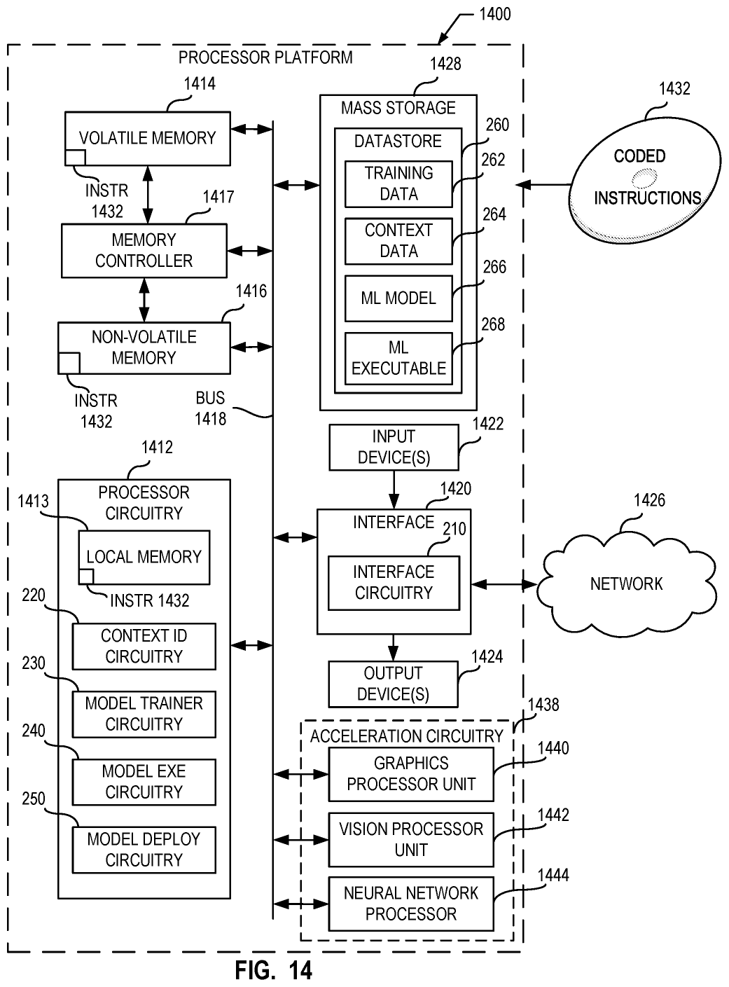

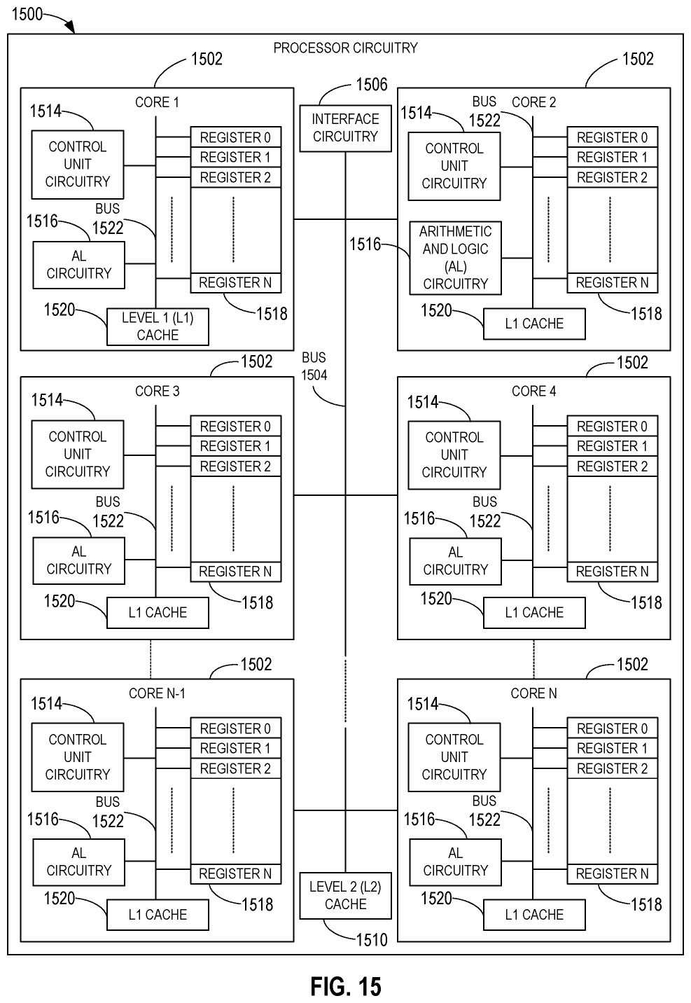

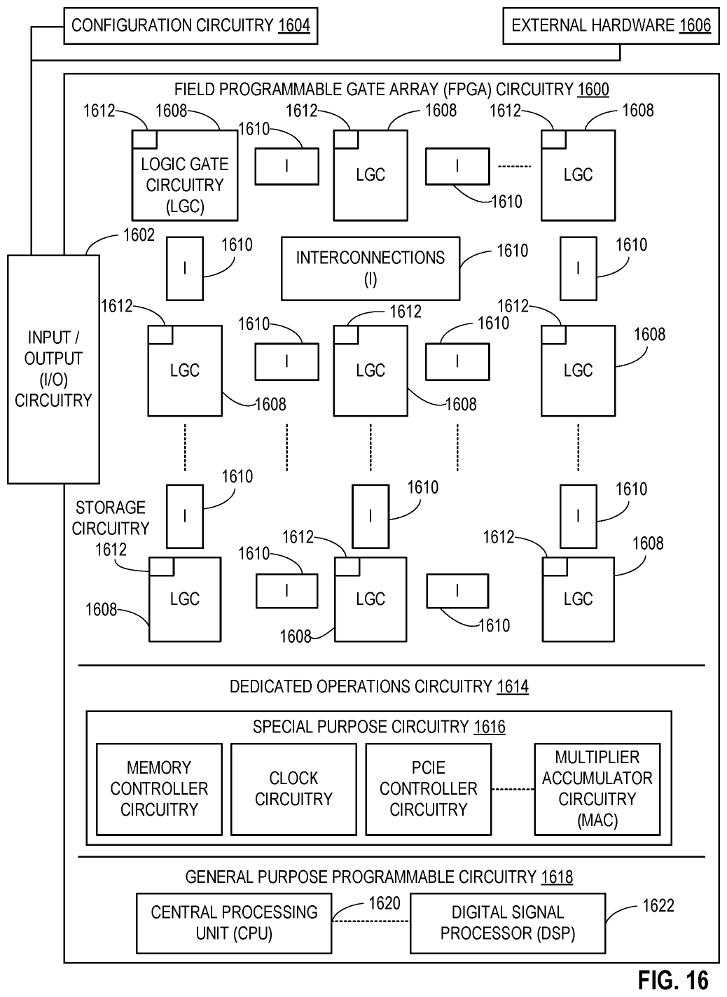

In some examples, the model handler circuitry 200 includes means for obtaining an indication from a first node to retrain a machine learning model. For example, the means for obtaining may be implemented by the interface circuitry 210. In some examples, the interface circuitry 210 may be instantiated by processor circuitry such as the example processor circuitry 1412 of FIG. 14. For instance, the interface circuitry 210 may be instantiated by the example general purpose processor circuitry 1500 of FIG. 15 executing machine executable instructions such as that implemented by at least block 916 of FIG. 9, block 1110 of FIG. 10, blocks 1202 and 1214 of FIG. 12, and/or block 1302 of FIG. 13. In some examples, the interface circuitry 210 may be instantiated by hardware logic circuitry, which may be implemented by an ASIC or the FPGA circuitry 1600 of FIG. 16 structured to perform operations corresponding to the machine readable instructions. Additionally or alternatively, the interface circuitry 210 may be instantiated by any other combination of hardware, software, and/or firmware. For example, the interface circuitry 210 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model handler circuitry 200 includes means for identifying context data as associated with a first node based on an identifier of the first node. In some examples, the means for identifying is to identify the context data to include at least one of a device type of the first node, a physical location of the first node, a type of sensor associated with the first node, environmental data associated with the first node, performance information associated with the first node, age information associated with the first node, hardware information associated with the first node, or software information associated with the first node. For example, the means for identifying may be implemented by the context identification circuitry 220. In some examples, the context identification circuitry 220 may be instantiated by processor circuitry such as the example processor circuitry 1412 of FIG. 14. For instance, the context identification circuitry 220 may be instantiated by the example general purpose processor circuitry 1500 of FIG. 15 executing machine executable instructions such as that implemented by at least block 1204 of FIG. 12 and/or block 1304 of FIG. 13. In some examples, the context identification circuitry 220 may be instantiated by hardware logic circuitry, which may be implemented by an ASIC or the FPGA circuitry 1600 of FIG. 16 structured to perform operations corresponding to the machine readable instructions. Additionally or alternatively, the context identification circuitry 220 may be instantiated by any other combination of hardware, software, and/or firmware. For example, the context identification circuitry 220 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

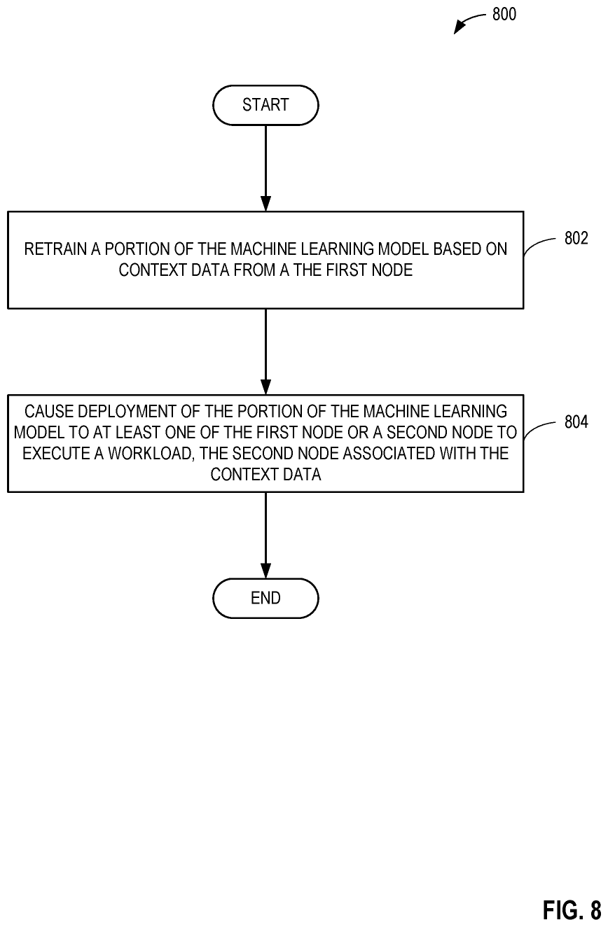

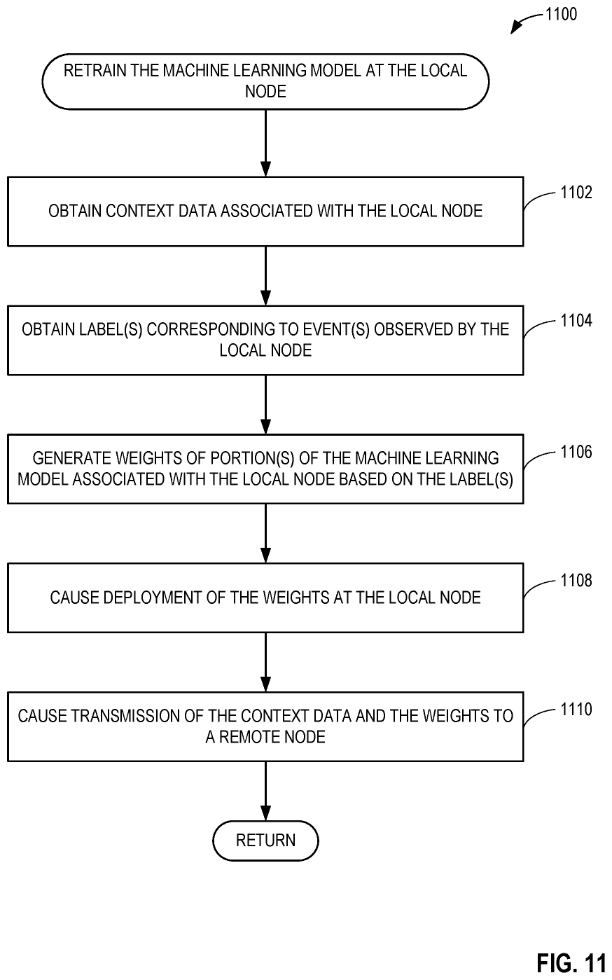

In some examples, the model handler circuitry 200 includes means for retraining a portion of a machine learning model based on context data from a first node. For example, the means for retraining may be implemented by the model trainer circuitry 230. In some examples, the model trainer circuitry 230 may be instantiated by processor circuitry such as the example processor circuitry 1412 of FIG. 14. For instance, the model trainer circuitry 230 may be instantiated by the example general purpose processor circuitry 1500 of FIG. 15 executing machine executable instructions such as that implemented by at least block 802 of FIG. 8, blocks 902, 904, 906, 908, 910, 912, 914 of FIG. 9, blocks 1002, 1004, 1008 of FIG. 10, blocks 1102, 1104, 1106, of FIG. 11, blocks 1206, 1208, 1210, 1212 of FIG. 12, and/or blocks 1306, 1308, 1310, 1312, 1314, 1316 of FIG. 13. In some examples, the model trainer circuitry 230 may be instantiated by hardware logic circuitry, which may be implemented by an ASIC or the FPGA circuitry 1600 of FIG. 16 structured to perform operations corresponding to the machine readable instructions. Additionally or alternatively, the model trainer circuitry 230 may be instantiated by any other combination of hardware, software, and/or firmware. For example, the model trainer circuitry 230 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples in which the portion of the machine learning model is a second portion of the machine learning model, the context data is second context data, the means for retraining is to instantiate the machine learning model for at least one of the first node or the second node, the first node associated with a first environment, the second node associated with at least one of the first environment or a second environment. In some examples, the means for retraining is to cluster first portions of the machine learning model into respective groups based on first context data, the first portions including the second portion, the first context data including at least one of the second context data or third context data, the third context data associated with the second node. In some examples, the means for retraining is to determine weights for the first portions of the machine learning model based on training data.

In some examples in which the first portions include a third portion, the means for retraining is to cluster the second portion of the machine learning model associated with at least one of the first node or the second node into a first group of the respective groups, the first group based on at least one of the second context data or the third context data. In some examples, the means for retraining is to cluster a third portion of the machine learning model associated with a third node into a second group of the respective groups, the second group based on third context data associated with the third node.

In some examples, the means for retraining is to identify the portion of the machine learning model based on the context data. In some examples, the means for retraining is to update second weights associated with the portion with the first weights from the first node to retrain the portion of the machine learning model.

In some examples in which the machine learning model includes first layers, the means for retraining is to instantiate a second layer of the machine learning model based on a generation of connections between the second layer and ones of the first layers, the first layers corresponding to a label from the first node, the label associated with at least one of a condition or event observed by the first node and/or at the first node. In some examples, the means for retraining is to update weights of the ones of the first layers based on the label.

In some examples, the model handler circuitry 200 includes means for executing an artificial intelligence and/or machine learning model. For example, the means for executing may be implemented by the model execution circuitry 240. In some examples, the model execution circuitry 240 may be instantiated by processor circuitry such as the example processor circuitry 1412 of FIG. 14. For instance, the model execution circuitry 240 may be instantiated by the example general purpose processor circuitry 1500 of FIG. 15 executing machine executable instructions such as that implemented by at least blocks 910, 912 of FIG. 9. In some examples, the model execution circuitry 240 may be instantiated by hardware logic circuitry, which may be implemented by an ASIC or the FPGA circuitry 1600 of FIG. 16 structured to perform operations corresponding to the machine readable instructions. Additionally or alternatively, the model execution circuitry 240 may be instantiated by any other combination of hardware, software, and/or firmware. For example, the model execution circuitry 240 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model handler circuitry 200 includes means for causing deployment of a portion of a machine learning model to at least one of a first node or a second node to execute a workload. In some examples, the second node is associated with the context data. For example, the means for causing may be implemented by the model deployment circuitry 250. In some examples, the model deployment circuitry 250 may be instantiated by processor circuitry such as the example processor circuitry 1412 of FIG. 14. For instance, the model deployment circuitry 250 may be instantiated by the example general purpose processor circuitry 1500 of FIG. 15 executing machine executable instructions such as that implemented by at least blocks 910, 912 of FIG. 9. In some examples, the model deployment circuitry 250 may be instantiated by hardware logic circuitry, which may be implemented by an ASIC or the FPGA circuitry 1600 of FIG. 16 structured to perform operations corresponding to the machine readable instructions. Additionally or alternatively, the model deployment circuitry 250 may be instantiated by any other combination of hardware, software, and/or firmware. For example, the model deployment circuitry 250 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for causing is to cause transmission of first weights to at least one of the second node or a third node. In some examples, the third node is associated with the context data.

In some examples in which the machine learning model includes first layers, the means for causing is to cause deployment of the portion of the machine learning model that corresponds to the ones of the first layers to at least one of the first node or the second node.

While an example manner of implementing the model handler 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the interface circuitry 210, the context identification circuitry 220, the model trainer circuitry 230, the model execution circuitry 240, the model deployment circuitry 250, the datastore 260, the bus 270, and/or, more generally, the example model handler 102 of FIG. 1, may be implemented by hardware alone or by hardware in combination with software and/or firmware. Thus, for example, any of the interface circuitry 210, the context identification circuitry 220, the model trainer circuitry 230, the model execution circuitry 240, the model deployment circuitry 250, the datastore 260, the bus 270, and/or, more generally, the example model handler 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example model handler 102 of FIG. 1 may include one or more elements, processes, and/or devices in addition to, or instead of, those illustrated in FIG. 2, and/or may include more than one of any or all of the illustrated elements, processes and devices.

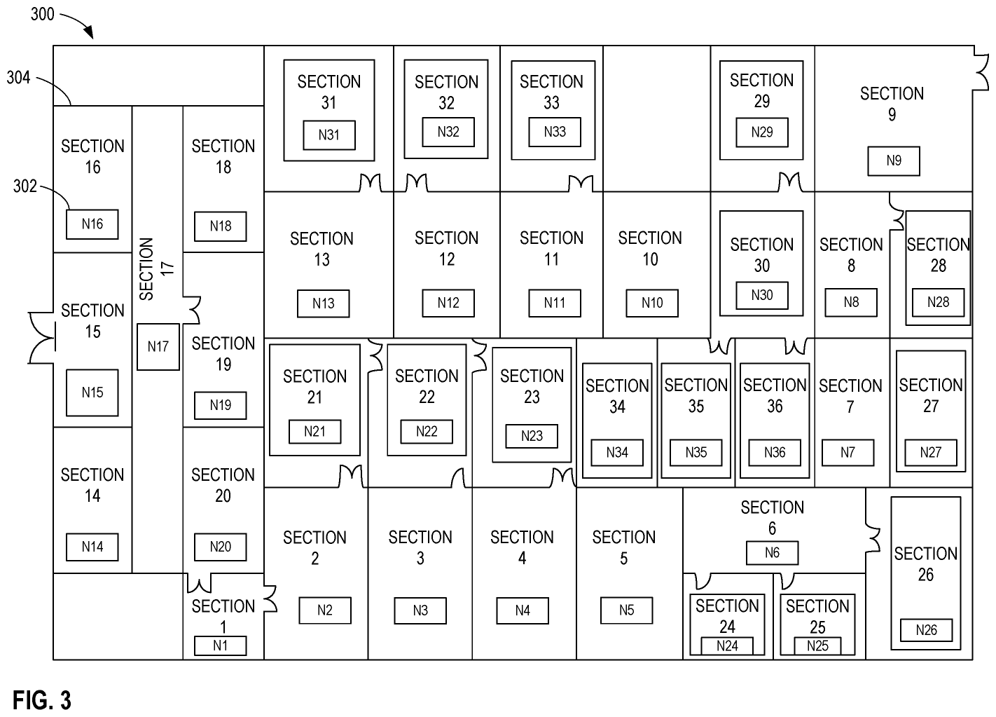

FIG. 3 is an illustration of a third example environment 300 including example nodes 302 (identified by nodes N1-N33) corresponding to example sections 304 of the third environment 300. In some examples, the third environment 300 can implement the first environment 124 and/or the second environment 126 of FIG. 1. In some examples, the nodes 302 can implement one(s) of the nodes 108, 110, 112, 114, 116, 118, 120, 122 of FIG. 1.

In the illustrated example, the third environment 300 is a physical environment, such as a factory, a hospital, retail store, etc., that includes multiple ones of the nodes 302 and areas (e.g., the sections 304) under inspection, monitoring, and/or otherwise observation by the nodes 302. For example, the nodes 302 can implement, include, and/or otherwise be associated with a sensor, such as a video camera, an RFID reader, etc.

In the illustrated example, the nodes 302 deployed in Section 18 (e.g., N18), Section 19 (e.g., N19), and Section 20 (e.g., N20) may include first cameras that observer very similar lighting conditions, while the nodes 302 deployed in Section 31 (e.g., N31), Section 32 (e.g., N32), and Section 33 (e.g., N33) may include second cameras that are closer to windows and thereby see bigger fluctuations during the day of their images, video feed, etc.

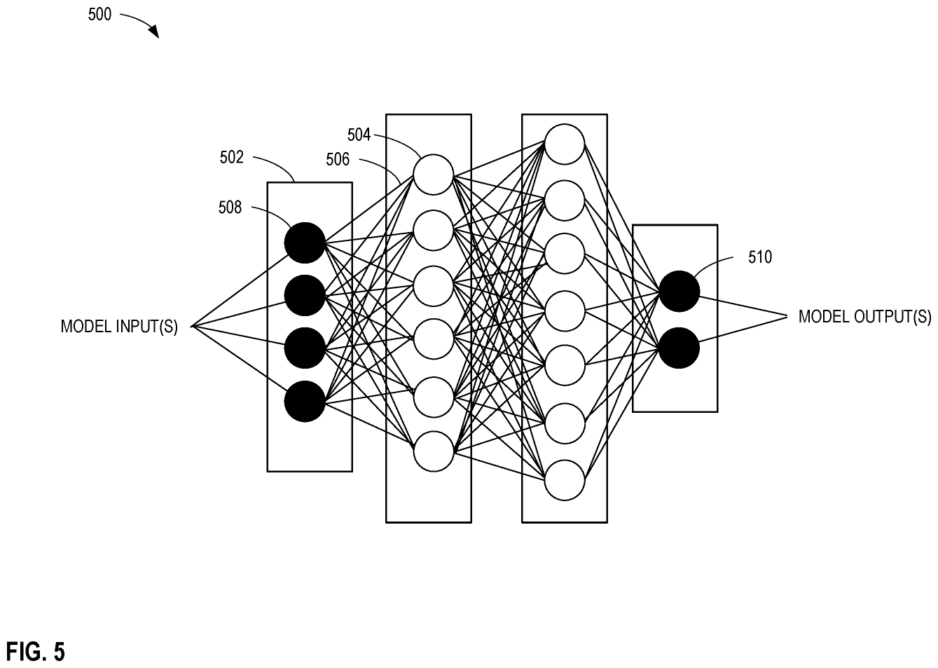

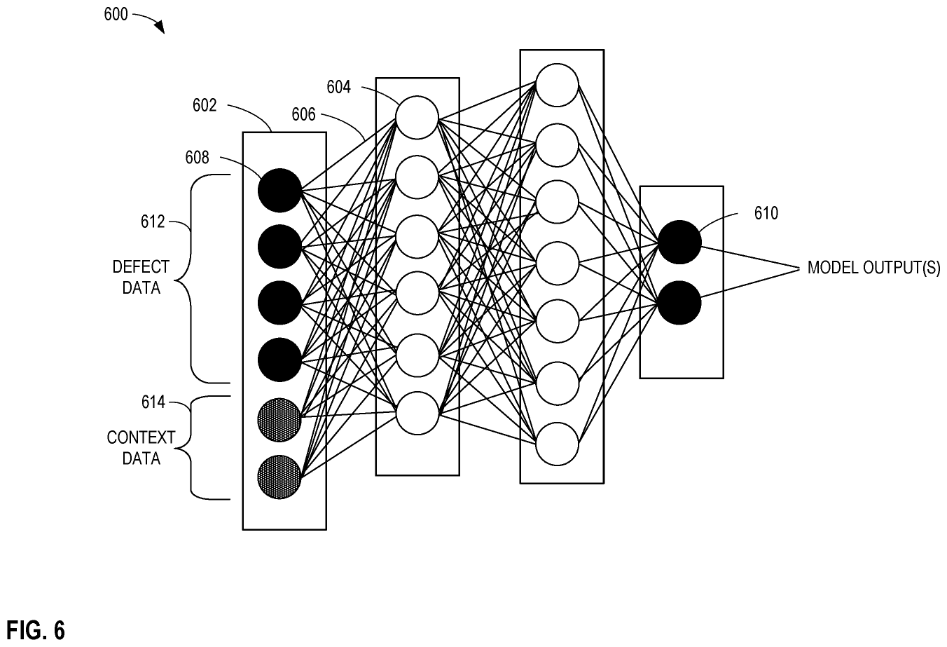

In the illustrated example, each of the sections 304 can deploy one or more of the nodes 302. In some examples, each of the nodes 302 can execute an ML model, such as one(s) of the ML models 104 of FIG. 1, one(s) of the ML models 138A-138H of FIG. 1, the ML model 266 of FIG. 2, etc. In some examples, each of the nodes 302 can execute an ML model as illustrated in the examples of FIGS. 5, 6, and/or 7.

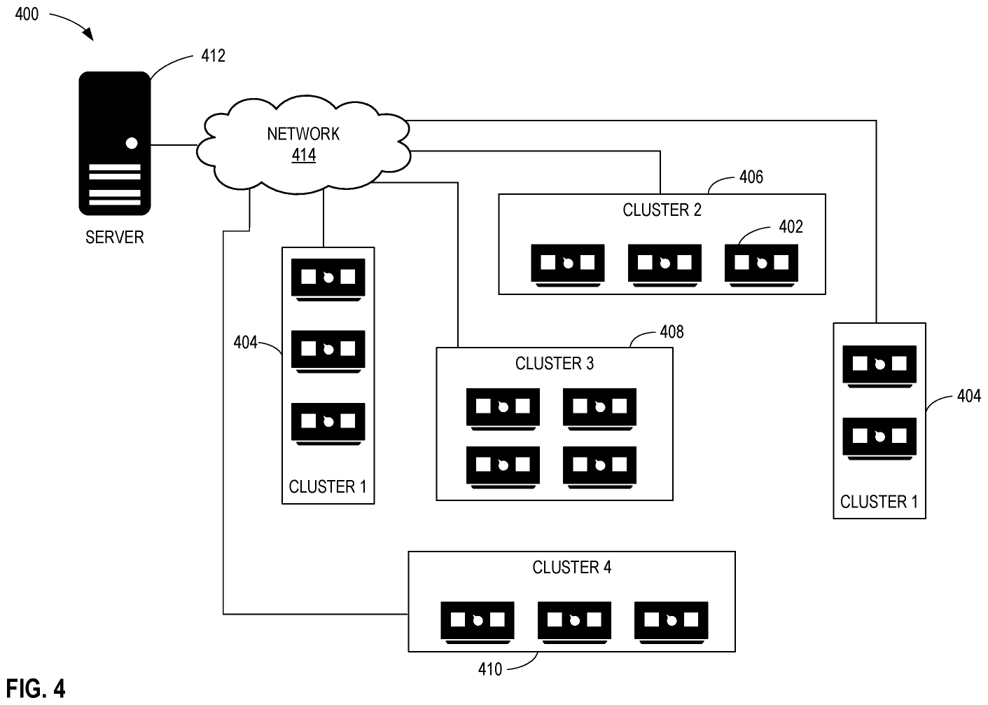

By way of example, the third environment 300 can be a factory and one of the nodes 302 in Section 31 (e.g., N31) may miss a defect in a product assembled in Section 31. In example operation, an operator in Section 31 can catch the defect and mark it in a system, such as the federated learning system 100 of FIG. 1. In example operation, the marking and/or otherwise identifying of a missed defect by the ML model can trigger a retraining request for the ML model. In example operation, the node in Section 31 can retrain the ML model and send the updated weights to a remote node, such as the server 128 of FIG. 1. In some examples, the remote node can identify cluster(s) of the nodes 302 of which to deploy the retrained ML model as described below in connection with FIG. 4.

FIG. 4 is an illustration of an example system 400 including example nodes 402 arranged into example clusters 404, 406, 408, 410 based on context data. Further depicted in FIG. 4 is an example server 412 and an example network 414. The clusters 404, 406, 408, 410 include a first example cluster 404 (identified by CLUSTER 1), a second example cluster 406 (identified by CLUSTER 2), a third example cluster 408 (identified by CLUSTER 3), and a fourth example cluster 410 (CLUSTER 4). In some examples, the nodes 402 can correspond to the nodes 108, 110, 112, 114, 116, 118, 120 122 of FIG. 1 and/or the nodes 302 of FIG. 3. In some examples, the server 412 can correspond to the server 128 of FIG. 1. In some examples, the network 414 can correspond to one(s) of the networks 130, 132, 134 of FIG. 1.

In example operation, the nodes 402 can provide their respective context data to the server 412. The server 412 can train an ML model, such as one(s) of the ML models 104 of FIG. 1, one(s) of the ML models 138A-138H of FIG. 1, the ML model 266 of FIG. 2, etc. For example, the server 412 can train the ML model based on the respective context data. In some examples, the server 412 can determine that five of the nodes 402 are associated with each other based on their context data and, based on the determination, can cluster the five of the nodes 402 into the first cluster 404. For example, each of the nodes 402 in the first cluster 404 can have the same or relatively similar device type (e.g., each of them are video cameras or a type of video camera, infrared camera, etc.), environmental conditions (e.g., lighting conditions, temperature conditions, etc.), locations (e.g., sections in close proximity to each other), etc., and/or any combination(s) thereof.

In example operation, the server 412 can identify portion(s) of the trained ML model that correspond to the clusters 404, 406, 408, 410. For example, the server 412 can identify a first portion of the trained ML model as corresponding to the first cluster 404 because the first portion can include layers, weights, etc., associated with the respective context data of the nodes 402 of the first cluster 404. Advantageously, the server 412 can distribute and/or otherwise deploy the first portion of the trained ML model to the nodes 402 of the first cluster 404. For example, the nodes 402 of the first cluster 404 can instantiate the first portion of the trained ML model as a lightweight ML model to execute ML workloads with reduced computational resources compared to the entirety of the trained ML model.

In example operation, a first one of the nodes 402 of the first cluster 404 can receive an indication (e.g., data input from a user at the first one of the nodes 402) that an event occurred that was not predicted or incorrectly predicted by the lightweight ML model. For example, the first one of the nodes 402 of the first cluster 404 can determine that the lightweight ML model is to be retrained using labeled training data. In some examples, the first one of the nodes 402 of the first cluster 404 can perform the retraining and generate new or updated weights. The first one of the nodes 402 of the first cluster 404 can distribute and/or otherwise provide the new or updated weights of the lightweight ML model to other one(s) of the nodes 402 of the first cluster 404. In some examples, the first one of the nodes 402 of the first cluster 404 can transmit the new or updated weights to the server 412 by way of the network 414. For example, the server 412 can identify the first cluster 404 based on an identifier of the first one of the nodes 402. In some examples, the server 412 can retrain the ML model and distribute portion(s) of the retrained ML model to the nodes 402 of the first cluster 404 and/or one(s) of the nodes 402 of different clusters. Advantageously, an ML model trained locally by one(s) of the nodes 402 and/or remotely at the server 412 can be partially retrained using context data to identify the portions of the ML model to retrain. Advantageously, the partially retrained ML model can improve an accuracy of ML workload outputs generated by the nodes 402 because the redeployed lightweight ML models at the nodes 402 have been retrained using data observed locally by the nodes 402.

FIG. 5 is an illustration of a first example ML model 500. For example, the first ML model 500 can implement the ML models 104 of FIG. 1, one(s) of the ML models 138A-138H of FIG. 1, the ML model 266 of FIG. 2, etc. The first ML model 500 of the illustrated example is a neural network including example layers 502, example neurons 504, and example connections 506. For example, the model execution circuitry 240 of FIG. 2, and/or, more generally, the model handler circuitry 200 of FIG. 2, can execute the first ML model 500 by providing example model input(s) 508 to the first ML model 500 to cause the first ML model 500 to generate example model output(s) 510. For example, the model input(s) 508 can be implemented by sensor data, training data, etc. In some examples, the model output(s) 510 can be implemented by a decision, a determination, a recommendation, etc., to carry out an action, operation, etc., in connection with a node, and/or, more generally, an environment. In some examples, the model handler circuitry 200 can retrain and/or improve the first ML model 500 based on context data to improve an accuracy of the model output(s) 510, which is described below in connection with FIG. 6. Alternatively, the first ML model 500 may be any other type of AI/ML model.

FIG. 6 is an illustration of a second example ML model 600. For example, the second ML model 600 can implement the ML models 104 of FIG. 1, one(s) of the ML models 138A-138H of FIG. 1, the ML model 266 of FIG. 2, the first ML model 500 of FIG. 5, etc. Alternatively, the second ML model 600 may be any other type of AWL model.

The second ML model 600 of the illustrated example of FIG. 6 is a neural network including example layers 602, example neurons 604, and example connections 606. For example, the model execution circuitry 240 of FIG. 2, and/or, more generally, the model handler circuitry 200 of FIG. 2, can execute the second ML model 600 by providing example model input(s) 608 to the second ML model 600 to cause the second ML model 600 to generate example model output(s) 610. For example, the model input(s) 608 can be implemented by sensor data, training data, etc. In some examples, the model output(s) 610 can be implemented by a decision, a determination, a recommendation, etc., to carry out an action, operation, etc., in connection with a node, and/or, more generally, an environment.

In the illustrated example, the model input(s) 608 include example defect data 612 and example context data 614. For example, the defect data 612 can be implemented using labeled data (e.g., labeled sensor data, labeled training data, etc.). In some examples, the defect data 612 can correspond to sensor data that is identified by a user, the model handler circuitry 200, etc., to be associated with an event in an environment. For example, the event can be an occurrence of a defect in a product on a factory assembly line that an AI/ML model did not detect, an identification of a dirty or unclean table in a restaurant that an AI/ML model erroneously identified as clean, etc. In some examples, the context data 614 can be implemented with the context data 106 of FIG. 1, the context data 136A-136H of FIG. 1, the context data 264 of FIG. 2, etc. For example, the context data 614 can correspond to context data associated with a node that generated and/or otherwise outputted the defect data 612.

Advantageously, the model handler circuitry 200 can augment and/or otherwise improve the second ML model 600 with the context data 614. For example, the model handler circuitry 200 can update the second ML model 600 by appending the context data 614 to the defect data 612. Advantageously, the model handler circuitry 200 can retrain the second ML model 600 based on combination(s) of the defect data 612 and the context data 614. For example, the model handler circuitry 200 can retrain the second ML model 600 or portion(s) thereof using the defect data 612 in view of the context data 614.

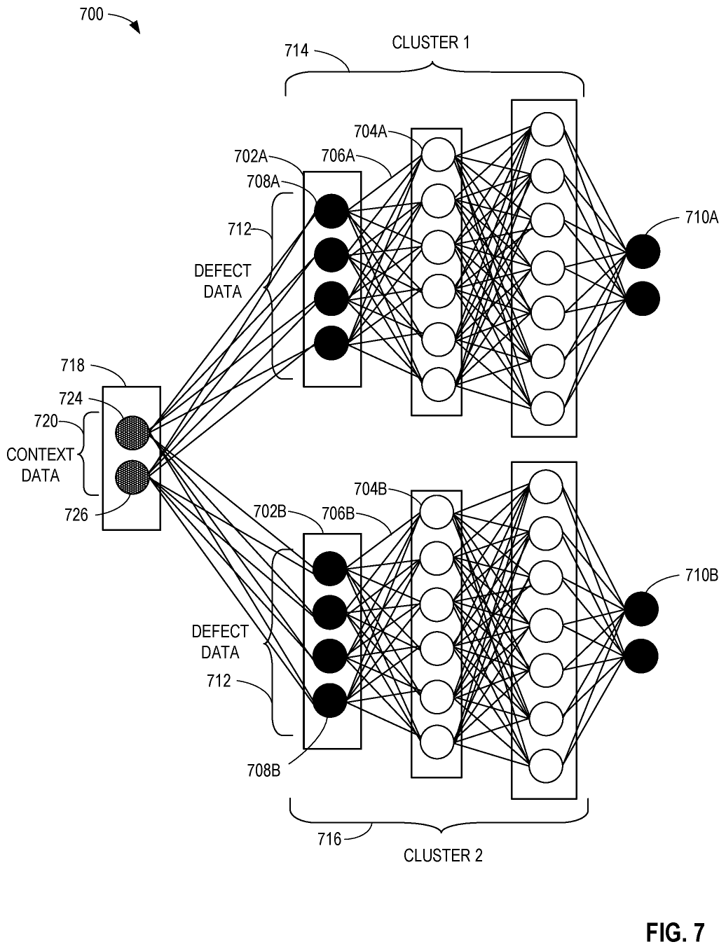

By way of example, the model handler circuitry 200 can obtain new weights generated via local retraining from the first node 108 (e.g., weights for one(s) of the neurons 604), the first node context data 136A (e.g., the context data 614 of FIG. 6), and labeled data (e.g., the defect data 612). In some examples, the model handler circuitry 200 can retrain the second ML model 600 to generate new one(s) of the model output(s) 610 that is/are indicative of detecting the defect data 612 based on at least one of the new weights or the context data 614. For example, the model handler circuitry 200 can train weights associated with the context data 614 into the second ML model 600 as described below in connection with FIG. 7 to improve accuracy and reduce complexity of an ML model, such as the second ML model 600.

FIG. 7 is an illustration of a third example ML model 700. For example, the third ML model 700 can implement the ML models 104 of FIG. 1, one(s) of the ML models 138A-138H of FIG. 1, the ML model 266 of FIG. 2, the first ML model 500 of FIG. 5, the second ML model 600 of FIG. 6, etc. The third ML model 700 of the illustrated example is a neural network including example layers 702A, 702B, example neurons 704A, 704B, and example connections 706A, 706B. Alternatively, the third ML model 700 may be any other type of AI/ML model. In example operation, the model execution circuitry 240 of FIG. 2, and/or, more generally, the model handler circuitry 200 of FIG. 2, can execute the third ML model 700 by providing example model input(s) 708A, 708B to the third ML model 700 to cause the third ML model 700 to generate example model output(s) 710A, 710B. For example, the model input(s) 708A, 708B can be implemented by sensor data, training data, etc. In some examples, the model output(s) 710A, 710B can be implemented by a decision, a determination, a recommendation, etc., to carry out an action, operation, etc., in connection with a node, and/or, more generally, an environment.

In some examples, the layers 702A, 702B are the same while in other examples, one(s) of the first layers 702A is/are different from one(s) of the second layers 702B. In some examples, the model inputs 708A, 708B, or portion(s) thereof, are the same while in other examples the model inputs 708A, 708B, or portion(s) thereof, are different. In some examples, the neurons 704A, 704B are the same while in other examples, one(s) of the first neurons 704A is/are different from one(s) of the second neurons 704B. In some examples, the connections 706A, 706B are the same while in other examples, one(s) of the first connections 706A is/are different from one(s) of the second connections 706B.

In the illustrated example, the model input(s) 708A, 708B include example defect data 712. For example, the defect data 712 can be implemented using labeled data (e.g., labeled sensor data, labeled training data, etc.). In some examples, the defect data 712 can correspond to sensor data that is identified by a user, the model handler circuitry 200, etc., to be associated with an event in an environment. For example, the event can be an occurrence of a vehicle on a roadway that an AI/ML model did not detect, an identification of an empty shelf in a warehouse that an AI/ML model erroneously identified as full or partially full, etc. In some examples, the defect data 712 can include LIDAR data from a LIDAR system that detected the vehicle, video data from a video camera that has a field of view that includes the empty shelf, etc.

In the illustrated example, the model handler circuitry 200 arranges portions of the third ML model 700 into example clusters 714, 716 including a first example cluster 714 (identified by CLUSTER 1) and a second example cluster 716 (identified by CLUSTER 2). In some examples, the first cluster 714 can correspond to layers of the third ML model 700 that are associated with the first cluster 404, the second cluster 406, the third cluster 408, and/or the fourth cluster 410 of FIG. 4. In some examples, the second cluster 716 can correspond to layers of the third ML model 700 that are associated with the first cluster 404, the second cluster 406, the third cluster 408, and/or the fourth cluster 410 of FIG. 4.

In some examples, the model handler circuitry 200 can generate the first cluster 714 by grouping together portions of the third ML model 700 that are associated with nodes of an environment, with the grouping of the portions based on context data of the nodes. For example, the model handler circuitry 200 can generate the first cluster 714 to be associated with the first node 108 and the second node 110 of the first environment 124 of FIG. 1 based on the first node context data 136A being associated with the second node context data 136B (e.g., a first portion of the first node context data 136A can match or partially match a second portion of the second node context data 136B). In some examples, the model handler circuitry 200 can generate the second cluster 716 to be associated with a different set of node(s), such as the third node 112 and the fourth node 114 of the first environment 124 of FIG. 1, based on the third node context data 136C being associated with the fourth node context data 136D (e.g., a first portion of the third node context data 136C can match or partially match a second portion of the fourth node context data 136D). Advantageously, in some examples, the model handler circuitry 200 can generate the clusters 714, 716 to arrange portion(s) of the third ML model 700 to be applicable to node(s) of an environment based on a similarity and/or matching (e.g., complete or partial matching) of their respective context data.

In the illustrated example, the model handler circuitry 200 augments and/or otherwise enhances the third ML model 700 by adding an example context data layer 718 that ingests example context data 720 as data inputs to the third ML model 700. In some examples, the context data 720 can be implemented with the context data 106 of FIG. 1, the context data 136A-136H of FIG. 1, the context data 264 of FIG. 2, etc. For example, the context data 720 can correspond to context data associated with a node that generated and/or otherwise led to the creation of the defect data 712.

Advantageously, the model handler circuitry 200 can create a series of ML models for each type of node. For example, the first ML model 138A and/or the second ML model 138B of FIG. 1 can correspond to the first cluster 714 of FIG. 7. In some examples, the third ML model 138C and/or the fourth ML model 138D can correspond to the second cluster 716 of FIG. 7. Advantageously, instead of relying on a user to manually decide on which nodes are which type (e.g., which portion of the third ML model 700 is applicable to a specific type of node), the model handler circuitry 200 determines which portion(s) of the third ML model 700 is/are applicable to a particular type of node (e.g., one(s) of the nodes 108, 110, 112, 114, 116, 118, 120, 122 of FIG. 1, a node with a particular type of sensor such as a video camera, etc.). Although only a single one of the context data layer 718 is depicted in the illustrated example of FIG. 7, additional context data layers may additionally and/or alternatively be used to implement the third ML model 700.

In the illustrated example of FIG. 7, the context data layer 718 can be implemented as a switch. For example, the context data layer 718 can be implemented as a switch layer, a gateway layer, a routing layer, or the like. For example, the context data layer 718 can include a first example neuron 724 with a weight value of 1.0 and a second example neuron 726 with a weight value of 0. In some examples, the model handler circuitry 200 can determine that if context data associated with a node corresponds to the first neuron 724, then the first cluster 714 is enabled and the second cluster 716 is disabled. For example, the first cluster 714 can be enabled based on multiplications of a weight value of 1 and weight values of the model inputs 708A yielding the weight values of the model inputs 708A. In some examples, the second cluster 716 can be disabled based on multiplications of a weight value of 0 and weight values of the model inputs 708B yielding values of 0.

By way of example, the model handler circuitry 200 can retrain the third ML model 700 in response to obtaining weights (e.g., weight values) for the first ML model 138A of FIG. 1 and the first node context data 136A. In some examples, the model handler circuitry 200 can determine that the weights are generated in response to the first node 108 retraining the first ML model 138A locally at the first node 108. In some examples, the model handler circuitry 200 can receive the first node context data 136A from the first node 108. For example, the weights can correspond to weights of the neurons 704A, 704B of FIG. 7 and the first node context data 136A can correspond to the context data 720 of FIG. 7.

In example operation, the model handler circuitry 200 can determine which portion(s) of the third ML model 700 is/are associated with the first node context data 136A. For example, the model handler circuitry 200 can determine that the first node context data 136A corresponds to the first neuron 724 and thereby corresponds to the first cluster 714. In some examples, the model handler circuitry 200 can determine based on an identifier of the first node 108 that the identifier corresponds to the first neuron 724 and thereby corresponds to the first cluster 714. Advantageously, the model handler circuitry 200 can retrain the first cluster 714 based on the weights from the first node 108 rather than retraining the entirety of the third ML model 700. Alternatively, the model handler circuitry 200 can retrain the entirety of the third ML model 700 based on the weights from the first node 108. Advantageously, in some examples, the model handler circuitry 200 can use weights from the first node 108 to generate a retrained portion of the third ML model 700 that is relevant to the first node 108. Advantageously, the model handler circuitry 200 can retrain the portion of the third ML model 700 to improve accuracy and reduce complexity of the third ML model 700 with respect to the first node 108 while minimizing and/or otherwise reducing an impact on other portion(s) of the third ML model 700, such as the second cluster 716, which may be relevant to different node(s) from the first node 108.

Advantageously, the model handler circuitry 200 can deploy portion(s) of the third ML model 700 as lightweight ML models to be instantiated and/or executed by a node. For example, the context data layer 718 and layers associated with the first cluster 714 can be deployed as a first lightweight model at the first node 108 and/or at node(s) associated with the first node 108, which may include the second node 110. In some examples, the context data layer 718 and layers associated with the second cluster 716 can be deployed as a second lightweight model at the third node 112 and/or at node(s) associated with the third node 112, which may include the fourth node 114.

Advantageously, in some examples, as the model handler circuitry 200 receives changes to models deployed at nodes from the nodes, the model handler circuitry 200 can compare the changes to existing models, such as the third ML model 700, and map these nodes using a context data layer, such as the first layer 720 of the third ML model 700. In some examples, with the example division depicted in FIG. 7, a node can run a subset of the third ML model 700, which can be similar and/or equivalent in size to the first ML model 500 of FIG. 5 and/or the second ML model 600 of FIG. 6.

Advantageously, by training portion(s) of the third ML model 700 that are relevant to a node requesting the training, network traffic can be substantially reduced as only changes to the portion(s) of the third ML model 700 are transmitted across a network (e.g., transmitted from the first node 108 to the server 128 by way of the first network 130 and the second network 132). For example, when one of the nodes 302 in Section 31 (e.g., N31) of FIG. 3 sends new or updated weights to the server 128 of FIG. 1, the server 128 can incorporate the new or updated weights into the portion(s) of the third ML model 700 that correspond to N31 (e.g., the context data of N31 is associated with the portion(s) of the third ML model 700 to be retrained). In some examples, the new or updated weights can be sent from the server 128 to the nodes 302 in Section 32 (e.g., N32) and Section 33 (e.g., N33) based on a determination that N32 and N33 have similar context data to N31. Advantageously, the ML model executed by the nodes 302 in Section 18 (e.g., N18), Section 19 (e.g., N19), and Section 20 (e.g., N20) can remain the same by not requiring an update based on a determination that N18-N20 do not have context data that is associated with the context data of N31.

Flowcharts representative of example hardware logic circuitry, machine readable instructions, hardware implemented state machines, and/or any combination thereof for implementing the model handler circuitry 200 of FIG. 2 are shown in FIGS. 8-13. The machine readable instructions may be one or more executable programs or portion(s) of an executable program for execution by processor circuitry, such as the processor circuitry 1412 shown in the example processor platform 1400 discussed below in connection with FIG. 14 and/or the example processor circuitry discussed below in connection with FIGS. 15 and/or 16. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 8-13, many other methods of implementing the example model handler circuitry 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-13 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer and/or machine readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed and/or instantiated by processor circuitry to deploy a portion of a machine learning model in a federated learning system. The machine readable instructions and/or the operations 800 of FIG. 8 begin at block 802, at which the model handler circuitry 200 retrains a portion of the machine learning model based on context data from a first node. For example, the model trainer circuitry 230 (FIG. 2) of the first node 108 can identify the first node 108 based on the first node context data 136A. In some examples, the model trainer circuitry 230 of the first node 108 can retrain the first ML model 138A locally at the first node 108 by generating new, updated, revised, etc., weights (e.g., neural network weights, AI/ML weights, etc.) of the first ML model 138A to generate model output(s) that correspond to a detection, an identification, etc., of an event, a condition, etc., observed by or at the first node 108. In some examples, the model trainer circuitry 230 of the server 128 can receive (i) an identifier that identifies the first node 108 and/or (ii) new, updated, revised, etc., weights from the first node 108. For example, the model trainer circuitry 230 of the server 128 can map the identifier to the first neuron 724 (e.g., the identifier can match or partially match data, such as metadata, of the first neuron 724). In some examples, the model trainer circuitry 230 of the server 128 can identify the first cluster 714 based on the mapping of the identifier to the first neuron 724 (e.g., the first neuron 724 is associated with a branch of the third ML model 700 that corresponds to the first cluster 714). The model trainer circuitry 230 of the server 128 can retrain the layers of the first cluster 714 based on the new, updated, revised, etc., weights from the first node 108. For example, the model trainer circuitry 230 of the server 128 can retrain the layers of the first cluster 714 while maintaining the layers of the second cluster 716 in their current state.

At block 804, the model handler circuitry 200 causes a deployment of the portion of the machine learning model to at least one of the first node or a second node to execute a workload, the second node associated with the context data. For example, the model deployment circuitry 250 (FIG. 2) of the first node 108 can update the first ML model 138A based on the new, revised, updated, etc., weights that are generated based on the labeled data. In some examples, the model deployment circuitry 250 of the server 128 can generate an executable (e.g., the machine learning executable 268) based on the third ML model 700 including the new, revised, updated, etc., weights obtained from the first node 108. For example, the model deployment circuitry 250 can identify the first node 108 and/or other node(s) that is/are associated with the first node 108 based on the context data 136A. For example, the model deployment circuitry 250 can determine that the identifier of the first node 108 is associated with the first node context data 136A. The model deployment circuitry 250 can determine that the first node context data 136A is associated with the second node context data 136B. The model deployment circuitry 250 can determine that the second node context data 136B is associated with the second ML model 138B. The model deployment circuitry 250 can determine that the updates to the first cluster 714 of the third ML model 700 can be applicable to and/or otherwise relevant to the first node 108 and the second node 110 based on the first node context data 136A and the second node context data 136B. The model deployment circuitry 250 can push, transmit, and/or otherwise cause delivery or deployment of the context data layer 718 and the first cluster 714 as a lightweight ML model executable to the first node 108 and/or the second node 110. In response to deploying the lightweight ML model executable at the first node 108 and/or the second node 110, the first node 108 and/or the second node 110 can execute and/or instantiate the lightweight ML model executable to execute a workload (e.g., an AI/ML workload such as object detection, stereo imaging, etc., and/or any combination(s) thereof). In some examples, the first node 108 can execute and/or instantiate the lightweight ML model executable to execute a first portion of the workload and the second node 110 can execute and/or instantiate the lightweight ML model executable to execute a second portion of the workload to effectuate distributed computing. In some examples, the model deployment circuitry 250 can push, transmit, and/or otherwise cause delivery of weights of the context data layer 718 and/or the first cluster 714 that changed in response to the retraining to reduce network traffic.

In response to deploying the portion of the machine learning model to at least one of the first node or a second node to execute a workload, the example machine readable instructions and/or the example operations 800 of FIG. 8 conclude.

FIG. 9 is a flowchart representative of example machine readable instructions and/or example operations 900 that may be executed and/or instantiated by processor circuitry to deploy a portion of a machine learning model in a federated learning system. The machine readable instructions and/or the operations 900 of FIG. 9 begin at block 902, at which the model handler circuitry 200 instantiates a machine learning model for nodes associated with an environment. For example, the model trainer circuitry 230 (FIG. 2) can generate and/or initialize a baseline or initial version of a first one of the ML models 104. In some examples, the first one of the ML models 104 can be identified for deployment to the first node 108, the second node 110, the third node 112, and the fourth node 114 of the first environment 124.

At block 904, the model handler circuitry 200 clusters portions of the machine learning model into respective groups based on context data associated with the nodes. For example, the model trainer circuitry 230 can associate the layers 702A of the third ML model 700 into a first group, such as the first cluster 714, and the layers 702B of the third ML model 700 into a second group, such as the second cluster 716. In some examples, the model trainer circuitry 230 can associate the layers 702A into the first group based on the layers 702A being associated with the first node context data 136A and the second node context data 136B. In some examples, the model trainer circuitry 230 can associate the layers 702B into the second group based on the layers 702B being associated with the third node context data 136C and the fourth node context data 136D.

At block 906, the model handler circuitry 200 determines weights for the portions of the machine learning model based on training data. For example, the model trainer circuitry 230 can calculate, compute, and/or otherwise determine values of weights of the neurons 704A, 704B of the third ML model 700. In some examples, the model trainer circuitry 230 can determine (e.g., iteratively determine) the values of the weights by predicting and/or otherwise outputting the model output(s) 710A, 710B in an effort to match labeled model output(s) 710A, 710B.

At block 908, the model handler circuitry 200 causes deployment of portion(s) of the machine learning model to corresponding nodes of at least one of the environment or a different environment to execute workloads. For example, the model deployment circuitry 250 (FIG. 2) can deploy a first portion of the third ML model 700, which can be the context data layer 718 and the first cluster 714, to the first node 108 and the second node 110. In some examples, the model deployment circuitry 250 can deploy a second portion of the third ML model 700, which can be the context data layer 718 and the second cluster 716, to the third node 112 and the fourth node 114. In some examples, the model deployment circuitry 250 can deploy the first portion as a first lightweight ML executable, the second portion as a second lightweight ML executable, etc. In some examples, the model deployment circuitry 250 can deploy the first portion as a first set of weight values, the second portion as a second set of weight values, etc. In some examples, the model deployment circuitry 250 can deploy the first portion to node(s) of the second environment 126 in response to a determination that the node(s) of the second environment 126 have context data that is/are associated with the first node context data 136A and/or the second node context data 136B.

At block 910, the model handler circuitry 200 generates machine learning output(s) using the portion(s) of the machine learning model based on input data associated with the at least one of the environment or the different environment. For example, the model execution circuitry 240 (FIG. 2) can generate the model output(s) 710A at the first node 108 based on providing sensor data captured by the first node 108 as the model input(s) 708A. In some examples, the model execution circuitry 240 can generate the model output(s) 710A rather than the model output(s) 710B at the first node 108 based on the first neuron 724 having a weight value of 1.0 (or any other non-zero value) and the second neuron having a weight value of 0. For example, the model trainer circuitry 230 can generate the first lightweight ML executable to have a non-zero value for the first neuron 724 and a zero value for the second neuron 726 based on the first node context data 136A and/or the second node context data 136B being associated with the first cluster 714. In some examples, the model trainer circuitry 230 can generate the second lightweight ML executable to have a zero value for the first neuron 724 and a non-zero value for the second neuron 726 based on the third node context data 136C and/or the fourth node context data 136D being associated with the second cluster 716.

At block 912, the model handler circuitry 200 determines whether the machine learning output(s) indicate(s) that portion(s) of the machine learning model is/are to be retrained. For example, the model execution circuitry 240 can determine whether the model output(s) 710A that is/are generated based on sensor data observed by the first node 108 are indicative that retraining of the first ML model 138A is needed. In some examples, a user associated with the first node 108 can identify a defect of a product or other undesirable occurrence that is not detected by the first ML model 138A. The first node 108 can obtain an indication from the user, such as data that, when ingested by the first node 108, can cause the first node 108 to trigger a retraining process of the first ML model 138A.

If, at block 912, the model handler circuitry 200 determines that the machine learning output(s) indicate(s) that portion(s) of the machine learning model is/are to be retrained, control proceeds to block 914. At block 914, the model handler circuitry 200 retrains the machine learning model based on context data associated with the machine learning output(s). For example, the model trainer circuitry 230 can retrain the first ML model 138A in response to the detection of the defect or other undesirable occurrence. In some examples, the model trainer circuitry 230 can retrain the first one of the ML models 104 in response to obtaining new or revised weights from the first node 108 that are generated in response to the detection of the defect or other undesirable occurrence. An example process that may be executed and/or instantiated by processor circuitry to implement block 914 is described below in connection with FIG. 10. In response to retraining the machine learning model based on context data associated with the machine learning output(s) at block 914, control returns to block 908 to deploy portion(s) of the machine learning model to corresponding nodes of at least one of the environment or a different environment to execute workloads.

If, at block 912, the model handler circuitry 200 determines that the machine learning output(s) do not indicate that portion(s) of the machine learning model is/are to be retrained, control proceeds to block 916. At block 916, the model handler circuitry 200 determines whether to continue monitoring for new input data. For example, the interface circuitry 210 (FIG. 2) can determine whether new sensor data is to be ingested that, when provided to the third ML model 700 as the model input(s) 708A, 708B, can cause the third ML model 700 to generate the model output(s) 710A, 710B to effectuate AI/ML workloads.

If, at block 916, the model handler circuitry 200 determines to continue monitoring for new input data, control returns to block 910, otherwise the example machine readable instructions and/or the example operations 900 of FIG. 9 conclude.

FIG. 10 is a flowchart representative of example machine readable instructions and/or example operations 1000 that may be executed and/or instantiated by processor circuitry to retrain a machine learning model based on context data associated with machine learning output(s). In some examples, the machine readable instructions and/or the operations 1000 of FIG. 10 can be executed and/or instantiated by processor circuitry to implement block 914 of the machine readable instructions and/or the operations 900 of FIG. 9. The machine readable instructions and/or the operations 1000 of FIG. 10 begin at block 1002, at which the model handler circuitry 200 determines whether to retrain the machine learning model at a local node or a remote node. For example, the model trainer circuitry (FIG. 2) can determine whether to retrain the first ML model 138A locally at the first node 108 using resource(s) (e.g., hardware, software, and/or firmware) of the first node 108 or at a remote node such as a different node (e.g., the second node 110, the fifth node 116, etc.) or the server 128.

If, at block 1002, the model handler circuitry 200 determines to retrain the machine learning model at the local node, control proceeds to block 1004. At block 1004, the model handler circuitry 200 retrains the machine learning model at the local node. For example, the model trainer circuitry 230 can retrain the first ML model 138A at the first node 108. An example process that may be executed and/or instantiated by processor circuitry to implement block 1004 is described below in connection with FIG. 11. In response to retraining the machine learning model at the local node, control proceeds to block 1006.

At block 1006, the model handler circuitry 200 updates the machine learning model at the remote node. For example, the interface circuitry 210 (FIG. 2) of the server 128 can receive weight values generated by the first node 108 that correspond to the first ML model 138A. In some examples, the model deployment circuitry 250 (FIG. 2) can update portion(s) of a first one of the ML models 104 based on the weight values. An example process that may be executed and/or instantiated by processor circuitry to implement block 1006 is described below in connection with FIG. 12. In response to updating the machine learning model at the remote node at block 1006, the example machine readable instructions and/or the example operations 1000 conclude. For example, the machine readable instructions and/or the operations 1000 can return to block 908 of the machine readable instructions and/or the operations 900 of FIG. 9 to deploy portion(s) of the machine learning model to corresponding nodes of at least one of an environment or a different environment to execute workloads.

If, at block 1002, the model handler circuitry 200 determines to retrain the machine learning model at the remote node, control proceeds to block 1008. At block 1008, the model handler circuitry 200 retrains the machine learning model at the remote node. For example, the interface circuitry 210 can receive retrain the first one of the ML models 104 based on at least one of labeled data or an identifier of the first node 108, which can be received from the first node 108. An example process that may be executed and/or instantiated by processor circuitry to implement block 1008 is described below in connection with FIG. 13. In response to retraining the machine learning model at the remote node at block 1008, the example machine readable instructions and/or the example operations 1000 conclude. For example, the machine readable instructions and/or the operations 1000 can return to block 908 of the machine readable instructions and/or the operations 900 of FIG. 9 to deploy portion(s) of the machine learning model to corresponding nodes of at least one of an environment or a different environment to execute workloads.

FIG. 11 is a flowchart representative of example machine readable instructions and/or example operations 1100 that may be executed and/or instantiated by processor circuitry to retrain a machine learning model at a local node. The machine readable instructions and/or the operations 1100 of FIG. 11 begin at block 1102, at which the model handler circuitry 200 obtains context data associated with the local node. For example, the model trainer circuitry 230 (FIG. 2) can obtain the context data 136A of the first node 108. In some examples, the first node context data 136A can be parameters, settings, etc., that define the first node 108, and/or, or more generally, the environment 124 in which the first node 108 is associated with. For example, the first node context data 136A can describe, explain, and/or otherwise define the first node 108 in a manner in which an algorithm, an electronic device, processor circuitry, etc., and/or any combination(s) thereof, can understand in the digital realm.

At block 1104, the model handler circuitry 200 obtains label(s) corresponding to event(s) observed by the local node. For example, the model trainer circuitry 230 can obtain a command, an instruction, etc., from a user that is indicative of an event that is mispredicted and/or otherwise erroneously analyzed by the first ML model 138A. In some examples, the model trainer circuitry 230 can obtain sensor data that corresponds to one or more time periods, durations, etc., during which the event occurred. For example, the model trainer circuitry 230 can assign a label to the sensor data to generate labeled data, which can be used by the model trainer circuitry 230 to retrain the first ML model 138A.

At block 1106, the model handler circuitry 200 generates weights of portion(s) of the machine learning model associated with the local node based on the label(s). For example, the model trainer circuitry 230 can generate weights of the first ML model 138A based on the labeled data using any type of AI/ML training or retraining technique.

At block 1108, the model handler circuitry 200 causes a deployment of the weights at the local node. For example, the model deployment circuitry 250 can deploy the weights at the first node 108 by updating the weights of the first ML model 108 with the weights generated by the training/retraining. In some examples, the model deployment circuitry 250 can output a new version of an executable that, when instantiated and/or executed by the first node 108, can implement the first ML model 138A based on the weights generated by the training/retraining.

At block 1110, the model handler circuitry 200 causes a transmission of the context data and the weights to a remote node. For example, the interface circuitry 210 (FIG. 2) can cause transmission and/or transmit at least one of the first node context data 136A or the new/revised/updated weights to a remote node, such as a different node of the first environment 124 or the second environment 126, the server 128, etc., and/or any combination(s) thereof.

In response to transmitting the context data and the weights to a remote node at block 1110, the example machine readable instructions and/or the example operations 1100 conclude. For example, the machine readable instructions and/or the operations 1100 can return to block 1006 of the machine readable instructions and/or the operations 1000 of FIG. 10 to update the machine learning model at the remote node.

FIG. 12 is a flowchart representative of example machine readable instructions and/or example operations 1200 that may be executed and/or instantiated by processor circuitry to update the machine learning model at a remote node. The machine readable instructions and/or the operations 1200 of FIG. 12 begin at block 1202, at which the model handler circuitry 200 obtains weights for portion(s) of a machine learning model associated with an environment from a node. For example, the interface circuitry 210 (FIG. 2) of the server 128 can receive weights associated with the first ML model 138A from the first node 108. In some examples, the interface circuitry 210 can determine that the weights are generated in response to a retraining of the first ML model 138A by the first node 108 or different node(s).

At block 1204, the model handler circuitry 200 determines context data associated with the node based on an identifier of the node. For example, the context identification circuitry 220 (FIG. 2) of the server 128 can determine that an identifier from the first node 108 is obtained with the weights. In some examples, the context identification circuitry 220 can map the identifier of the first node 108 to portion(s) of the context data 264 (FIG. 2), which can include the first node context data 136A. In some examples, the context identification circuitry 220 can determine that the first node context data 136A is associated with the first node 108 based on the identifier of the first node 108.

At block 1206, the model handler circuitry 200 identifies the portion(s) of the machine learning model to retrain based on the context data. For example, the model trainer circuitry 230 (FIG. 2) can determine that the first cluster 714 of the third ML model 700 is associated with the first node context data 136A.

At block 1208, the model handler circuitry 200 determines whether only portion(s) associated with the context data is/are to be retrained. For example, the model trainer circuitry 230 can determine whether (i) the first cluster 714 of the third ML model 700 is to be retrained or (ii) an entirety of the third ML model 700 is to be retrained based on the weights from the first node 108.

If, at block 1208, the model handler circuitry 200 determines that not only the portion(s) associated with the context data is/are to be retrained, control proceeds to block 1210. At block 1210, the model handler circuitry 200 updates weights for the machine learning model based on the weights obtained from the node. For example, the model trainer circuitry 230 can update the entirety of the third ML model 700 using the weights. In some examples, the model trainer circuitry 230 can update each affected weight with respective values of the new weights received from the first node 108, average each affected weight based on the prior value and the new values of the affected weights, etc. In response to updating the weights for the machine learning model based on the weights obtained from the node at block 1210, control proceeds to block 1214.

If, at block 1208, the model handler circuitry 200 determines that only portion(s) associated with the context data is/are to be retrained, control proceeds to block 1212. At block 1212, the model handler circuitry 200 updates weights for the portion(s) associated with the context data based on the weights from the node. For example, the model trainer circuitry 230 can update the first cluster 714 of the third ML model 700 using the weights. In some examples, the model trainer circuitry 230 can update each affected weight with respective values of the new weights received from the first node 108, average each affected weight based on the prior value and the new values of the affected weights, etc. In response to updating the weights for portion(s) associated with the context data based on the weights from the node at block 1212, control proceeds to block 1214.

At block 1214, the model handler circuitry 200 causes transmission of the weights to node(s) of the environment that correspond to the context data. For example, the interface circuitry 210 can transmit the new values of the affected weights to the second node 110 based on a determination that the second node context data 136B is associated with the first node context data 136A. In response to transmitting the weights to node(s) of the environment that correspond to the context data at block 1214, the example machine readable instructions and/or the example operations 1200 conclude. For example, the machine readable instructions and/or the operations 1200 can return to block 908 of the machine readable instructions and/or the operations 900 of FIG. 9 to deploy portion(s) of the machine learning model to corresponding nodes of at least one of an environment or a different environment to execute workloads.

FIG. 13 is a flowchart representative of example machine readable instructions and/or example operations 1300 that may be executed and/or instantiated by processor circuitry to retrain the machine learning model at the remote node. The example machine readable instructions and/or the example operations 1300 of FIG. 13 begin at block 1302, at which the model handler circuitry 200 obtains label(s) associated with event(s) observed by a node. For example, the interface circuitry 210 (FIG. 2) of the server 128 can receive labeled data associated with an event observed by the first node 108 in the first environment 124.

At block 1304, the model handler circuitry 200 determines context data associated with the node based on an identifier of the node. For example, the context identification circuitry 220 (FIG. 2) of the server 128 can determine that an identifier from the first node 108 is obtained with the labeled data. In some examples, the context identification circuitry 220 can map the identifier of the first node 108 to portion(s) of the context data 264 (FIG. 2), which can include the first node context data 136A. In some examples, the context identification circuitry 220 can determine that the first node context data 136A is associated with the first node 108 based on the identifier of the first node 108.

At block 1306, the model handler circuitry 200 identifies cluster(s) of the machine learning model to retrain based on the context data. For example, the model trainer circuitry 230 (FIG. 2) can determine that the first cluster 714 of the third ML model 700 is associated with the first node context data 136A.

At block 1308, the model handler circuitry 200 determines whether to instantiate new layer(s) of the machine learning model based on the label(s) corresponding to a subset of the machine learning model. For example, the model trainer circuitry 230 can determine that the labeled data is associated with and/or otherwise related to the first cluster 714 and not the second cluster 716. In some examples, the model trainer circuitry 230 can determine to create the context data layer 718 to be operative as a switch to select between the first cluster 714 or the second cluster 716. For example, the model trainer circuitry 230 can generate the context data layer 718 to function as the switch by setting a first value of the first neuron 724 to a non-zero value (e.g., a value of 1.0) and a second value of the second neuron 726 to 0.

If, at block 1308, the model handler circuitry determines not to instantiate new layer(s) of the machine learning model based on the label(s) corresponding to a subset of the machine learning model, control proceeds to block 1312. If, at block 1308, the model handler circuitry determines to instantiate new layer(s) of the machine learning model based on the label(s) corresponding to a subset of the machine learning model, control proceeds to block 1310.

At block 1310, the model handler circuitry 200 instantiates the new layer(s) based on a generation of connection(s) to existing layer(s) that correspond to the subset of the machine learning model. For example, the model trainer circuitry 230 can instantiate the context data layer 718 by generating ones of the connections 706A, 706B between the first neuron 724 and the second neuron 726 and ones of the model input(s) 708A, 708B.

At block 1312, the model handler circuitry 200 determines whether only cluster(s) associated with the context data is/are to be updated. For example, the model trainer circuitry 230 can determine whether (i) the first cluster 714 of the third ML model 700 is to be retrained or (ii) an entirety of the third ML model 700 is to be retrained based on the labeled data.

If, at block 1312, the model handler circuitry 200 determines that not only cluster(s) associated with the context data is/are to be updated, control proceeds to block 1314. At block 1314, the model handler circuitry 200 updates weights for the machine learning model based on the label(s). For example, the model trainer circuitry 230 can update the entirety of the third ML model 700 (e.g., weight values of the neurons 704A, 704B) using the labeled data by any AI training/retraining technique. In response to updating the weights for the machine learning model based on the label(s) at block 1314, control proceeds to block 1318.

If, at block 1312, the model handler circuitry 200 determines that only cluster(s) associated with the context data is/are to be updated, control proceeds to block 1316. At block 1316, the model handler circuitry 200 updates weights for the cluster(s) associated with the context data based on the label(s). For example, the model trainer circuitry 230 can update weights of the neurons 704A of the first cluster 714 of the third ML model 700 based on the labeled data using any AI/ML training/retraining technique. In response to updating the weights for the cluster(s) associated with the context data based on the label(s) at block 1316, control proceeds to block 1318.

At block 1318, the model handler circuitry 200 causes a deployment of portion(s) of the machine learning model with the updated weights to node(s) associated with the context data. For example, the model deployment circuitry 250 (FIG. 2) can generate the machine learning executable 268 (FIG. 2) based on the machine learning model 266, which can correspond to the trained/retrained version of the third ML model 700. In some examples, the interface circuitry 210 can transmit the machine learning executable 268 to the first node 108. For example, the first node 108 can deploy the machine learning executable 268 at the first node 108 as a lightweight ML model to execute AI/ML workloads.

In some examples, the interface circuitry 210 can transmit values of the third ML model 700 that changed in response to the training/retraining. Advantageously, the interface circuitry 210 can transmit the changed values to the first node 108 to reduce network traffic associated with the first network 130 and/or the second network 132. In response to receiving the changed values, the first node 108 can update the first ML model 138A at the first node 108 with the changed values. In response to deploying portion(s) of the machine learning model with the updated weights to node(s) associated with the context data at block 1318, the example machine readable instructions and/or the example operations 1300 conclude. For example, the machine readable instructions and/or the operations 1300 of FIG. 13 can return to block 908 of the machine readable instructions and/or the operations 900 of FIG. 9 to deploy portion(s) of the machine learning model to corresponding nodes of at least one of an environment or a different environment to execute workloads.

FIG. 14 is a block diagram of an example processor platform 1400 structured to execute and/or instantiate the machine readable instructions and/or the operations of FIGS. 8-13 to implement the model handler circuitry 200 of FIG. 2. The processor platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1400 of the illustrated example includes processor circuitry 1412. The processor circuitry 1412 of the illustrated example is hardware. For example, the processor circuitry 1412 can be implemented by one or more integrated circuits, logic circuits, FPGAs, microprocessors, CPUs, GPUs, DSPs, and/or microcontrollers from any desired family or manufacturer. The processor circuitry 1412 may be implemented by one or more semiconductor based (e.g., silicon based) devices. In this example, the processor circuitry 1412 implements the context identification circuitry 220 (identified by CONTEXT ID CIRCUITRY), the model trainer circuitry 230, the model execution circuitry 240 (identified by MODEL EXE CIRCUITRY), and the model deployment circuitry 250 (identified by MODEL DEPLOY CIRCUITRY) of FIG. 2.

The processor circuitry 1412 of the illustrated example includes a local memory 1413 (e.g., a cache, registers, etc.). The processor circuitry 1412 of the illustrated example is in communication with a main memory including a volatile memory 1414 and a non-volatile memory 1416 by a bus 1418. In some examples, the bus 1418 can implement the bus 270 of FIG. 2. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417.

The processor platform 1400 of the illustrated example also includes interface circuitry 1420. In this example, the interface circuitry 1420 implements the interface circuitry 210 of FIG. 2. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user to enter data and/or commands into the processor circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system. For example, the input device(s) 1422 can be implemented by one or more sensors as described herein.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1400 of the illustrated example also includes one or more mass storage devices 1428 to store software and/or data. In this example, the one or more mass storage devices 1428 implement the datastore 260, which stores the training data 262, the context data 264, the machine learning model 266 (identified by ML MODEL), and the machine learning executable 268 (identified by ML EXECUTABLE) of FIG. 2. Examples of such mass storage devices 1428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The processor platform 1400 of the illustrated example of FIG. 14 includes example acceleration circuitry 1438, which includes an example graphics processing unit (GPU) 1440, an example vision processing unit (VPU) 1442, and an example neural network processor 1444. In this example, the GPU 1440, the VPU 1442, and the neural network processor 1444 are in communication with different hardware of the processor platform 1400, such as the volatile memory 1414, the non-volatile memory 1416, etc., via the bus 1418. In this example, the neural network processor 1444 may be implemented by one or more integrated circuits, logic circuits, microprocessors, GPUs, DSPs, or controllers from any desired family or manufacturer that can be used to execute an AI model, such as a neural network, which may be implemented by the ML model 266. In some examples, one or more of the context identification circuitry 220, the model trainer circuitry 230, the model execution circuitry 240, and/or the model deployment circuitry 250 can be implemented in or with at least one of the GPU 1440, the VPU 1442, or the neural network processor 1444 instead of or in addition to the processor circuitry 1412.

The machine executable instructions 1432, which may be implemented by the machine readable instructions of FIGS. 8-13, may be stored in the mass storage device 1428, in the volatile memory 1414, in the non-volatile memory 1416, and/or on a removable non-transitory computer readable storage medium such as a CD or DVD.

FIG. 15 is a block diagram of an example implementation of the processor circuitry 1412 of FIG. 14. In this example, the processor circuitry 1412 of FIG. 14 is implemented by a general purpose microprocessor 1500. The general purpose microprocessor circuitry 1500 executes some or all of the machine readable instructions of the flowcharts of FIGS. 8-13 to effectively instantiate the model handler circuitry 200 of FIG. 2 as logic circuits to perform the operations corresponding to those machine readable instructions. In some such examples, the model handler circuitry 200 of FIG. 2 is instantiated by the hardware circuits of the microprocessor 1500 in combination with the instructions. For example, the microprocessor 1500 may implement multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowcharts of FIGS. 8-13.

The cores 1502 may communicate by a first example bus 1504. In some examples, the first bus 1504 may implement a communication bus to effectuate communication associated with one(s) of the cores 1502. For example, the first bus 1504 may implement at least one of an Inter-Integrated Circuit (I2C) bus, a Serial Peripheral Interface (SPI) bus, a PCI bus, or a PCIe bus. Additionally or alternatively, the first bus 1504 may implement any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2_cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the L1 cache 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating point operations. In yet other examples, the AL circuitry 1516 may include first AL circuitry that performs integer based operations and second AL circuitry that performs floating point operations. In some examples, the AL circuitry 1516 may be referred to as an Arithmetic Logic Unit (ALU). The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The second bus 1522 may implement at least one of an I2C bus, a SPI bus, a PCI bus, or a PCIe bus

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 16 is a block diagram of another example implementation of the processor circuitry 1412 of FIG. 14. In this example, the processor circuitry 1412 is implemented by FPGA circuitry 1600. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the machine readable instructions in hardware and, thus, can often execute the operations faster than they could be performed by a general purpose microprocessor executing the corresponding software.

More specifically, in contrast to the microprocessor 1500 of FIG. 15 described above (which is a general purpose device that may be programmed to execute some or all of the machine readable instructions represented by the flowcharts of FIGS. 8-13 but whose interconnections and logic circuitry are fixed once fabricated), the FPGA circuitry 1600 of the example of FIG. 16 includes interconnections and logic circuitry that may be configured and/or interconnected in different ways after fabrication to instantiate, for example, some or all of the machine readable instructions represented by the flowcharts of FIGS. 8-13. In particular, the FPGA 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the software represented by the flowcharts of FIGS. 8-13. As such, the FPGA circuitry 1600 may be structured to effectively instantiate some or all of the machine readable instructions of the flowcharts of FIGS. 8-13 as dedicated logic circuits to perform the operations corresponding to those software instructions in a dedicated manner analogous to an ASIC. Therefore, the FPGA circuitry 1600 may perform the operations corresponding to the some or all of the machine readable instructions of FIGS. 8-13 faster than the general purpose microprocessor can execute the same.

In the example of FIG. 16, the FPGA circuitry 1600 is structured to be programmed (and/or reprogrammed one or more times) by an end user by a hardware description language (HDL) such as Verilog. The FPGA circuitry 1600 of FIG. 16, includes example input/output (I/O) circuitry 1602 to obtain and/or output data to/from example configuration circuitry 1604 and/or external hardware (e.g., external hardware circuitry) 1606. For example, the configuration circuitry 1604 may implement interface circuitry that may obtain machine readable instructions to configure the FPGA circuitry 1600, or portion(s) thereof. In some such examples, the configuration circuitry 1604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1606 may implement the microprocessor 1500 of FIG. 15. The FPGA circuitry 1600 also includes an array of example logic gate circuitry 1608, a plurality of example configurable interconnections 1610, and example storage circuitry 1612. The logic gate circuitry 1608 and interconnections 1610 are configurable to instantiate one or more operations that may correspond to at least some of the machine readable instructions of FIGS. 8-13 and/or other desired operations. The logic gate circuitry 1608 shown in FIG. 16 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations. The logic gate circuitry 1608 may include other electrical structures such as look-up tables (LUTs), registers (e.g., flip-flops or latches), multiplexers, etc.

The interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example Dedicated Operations Circuitry 1614. In this example, the Dedicated Operations Circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the processor circuitry 1412 of FIG. 14, many other approaches are contemplated. For example, as mentioned above, modern FPGA circuitry may include an on-board CPU, such as one or more of the example CPU 1620 of FIG. 16. Therefore, the processor circuitry 1412 of FIG. 14 may additionally be implemented by combining the example microprocessor 1500 of FIG. 15 and the example FPGA circuitry 1600 of FIG. 16. In some such hybrid examples, a first portion of the machine readable instructions represented by the flowcharts of FIGS. 8-13 may be executed by one or more of the cores 1502 of FIG. 15, a second portion of the machine readable instructions represented by the flowcharts of FIGS. 8-13 may be executed by the FPGA circuitry 1600 of FIG. 16, and/or a third portion of the machine readable instructions represented by the flowcharts of FIGS. 8-13 may be executed by an ASIC. It should be understood that some or all of the model handler circuitry 200 of FIG. 2 may, thus, be instantiated at the same or different times. Some or all of the circuitry may be instantiated, for example, in one or more threads executing concurrently and/or in series. Moreover, in some examples, some or all of the model handler circuitry 200 of FIG. 2 may be implemented within one or more virtual machines and/or containers executing on the microprocessor.

In some examples, the processor circuitry 1412 of FIG. 14 may be in one or more packages. For example, the processor circuitry 1500 of FIG. 15 and/or the FPGA circuitry 1600 of FIG. 16 may be in one or more packages. In some examples, an XPU may be implemented by the processor circuitry 1412 of FIG. 14, which may be in one or more packages. For example, the XPU may include a CPU in one package, a DSP in another package, a GPU in yet another package, and an FPGA in still yet another package.

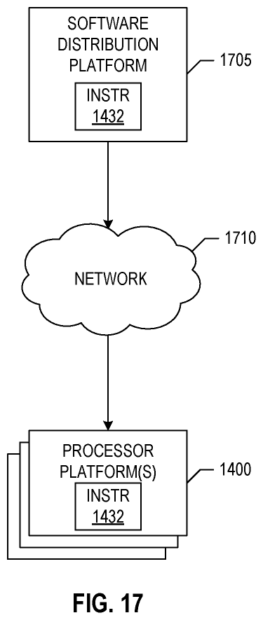

A block diagram illustrating an example software distribution platform 1705 to distribute software such as the example machine readable instructions 1432 of FIG. 14 to hardware devices owned and/or operated by third parties is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1432, which may correspond to the example machine readable instructions 800, 900, 1000, 1100, 1200, 1300 of FIGS. 8-13, as described above. The one or more servers of the example software distribution platform 1705 are in communication with a network 1710, which may correspond to any one or more of the Internet and/or any of the example networks 130, 132, 134, 414, 1426 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1705. For example, the software, which may correspond to the example machine readable instructions 800, 900, 1000, 1100, 1200, 1300 of FIGS. 8-13, may be downloaded to the example processor platform 1400, which is to execute the machine readable instructions 1432 to implement the model handler circuitry 200 of FIG. 2. In some example, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices.

From the foregoing, it will be appreciated that example systems, methods, apparatus, and articles of manufacture have been disclosed for clustered federated learning using context data. Disclosed systems, methods, apparatus, and articles of manufacture expand inputs to AI/ML federated learning systems to include contextual data about a node that is reporting an update of an existing model or is requesting a retraining of the existing model. Disclosed systems, methods, apparatus, and articles of manufacture cluster nodes that are similar to each other based on their respective context data to specialize and/or otherwise tailor the models they execute to the data that is most relevant to them. Disclosed systems, methods, apparatus, and articles of manufacture provide an example framework that allows a subset of a model to be deployed on resource constrained nodes if needed. Disclosed systems, methods, apparatus, and articles of manufacture improve the efficiency of using a computing device by achieving improved federated learning that can provide increased accuracy while allowing for the deployment of smaller, lightweight models that have increased relevance to local nodes in an environment. Disclosed systems, methods, apparatus, and articles of manufacture can achieve improved efficiency by reducing utilization of resources needed to train and/or execute an AI/ML model because a portion of the AI/ML model can be trained and/or executed. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for clustered federated learning using context data are disclosed herein. Further examples and combinations thereof include the following:

Example 1 includes an apparatus for clustered federated learning, the apparatus comprising at least one memory, instructions, and processor circuitry to at least one of instantiate or execute the instructions to retrain a portion of a machine learning model based on context data from a first node, and cause deployment of the portion of the machine learning model to at least one of the first node or a second node to execute a workload, the second node associated with the context data.

In Example 2, the subject matter of Example 1 can optionally include that the processor circuitry is to determine the context data associated with the first node based on an identifier of the first node.

In Example 3, the subject matter of Examples 1-2 can optionally include that the processor circuitry is to determine that the context data includes at least one of a device type of the first node, a physical location of the first node, a type of sensor associated with the first node, environmental data associated with the first node, performance information associated with the first node, age information associated with the first node, hardware information associated with the first node, or software information associated with the first node.

In Example 4, the subject matter of Examples 1-3 can optionally include that the portion of the machine learning model is a second portion of the machine learning model, the context data is second context data, and the processor circuitry is to instantiate the machine learning model for at least one of the first node or the second node, the first node associated with a first environment, the second node associated with at least one of the first environment or a second environment, cluster first portions of the machine learning model into respective groups based on first context data, the first portions including the second portion, the first context data including at least one of the second context data or third context data, the third context data associated with the second node, and determine weights for the first portions of the machine learning model based on training data.

In Example 5, the subject matter of Examples 1-4 can optionally include that the first portions include a third portion, and the processor circuitry is to cluster the second portion of the machine learning model associated with at least one of the first node or the second node into a first group of the respective groups, the first group based on at least one of the second context data or the third context data, and cluster a third portion of the machine learning model associated with a third node into a second group of the respective groups, the second group based on third context data associated with the third node.

In Example 6, the subject matter of Examples 1-5 can optionally include that the processor circuitry is to obtain first weights for the portion of the machine learning model from the first node, the first weights generated by the first node based on a label from the first node corresponding to an event observed by the first node, determine the context data associated with the first node based on an identifier of the first node, identify the portion of the machine learning model based on the context data, update second weights associated with the portion with the first weights from the first node to retrain the portion of the machine learning model, and cause transmission of the first weights to at least one of the second node or a third node, the third node associated with the context data.

In Example 7, the subject matter of Examples 1-6 can optionally include that the machine learning model includes first layers, and the processor circuitry is to instantiate a second layer of the machine learning model based on a generation of connections between the second layer and ones of the first layers, the ones of the first layers corresponding to a subset of the machine learning model associated with a label, the label corresponding to an event observed by the first node, update weights of the ones of the first layers based on the label, and cause deployment of the portion of the machine learning model that corresponds to the ones of the first layers to at least one of the first node or the second node.

In Example 8, the subject matter of Examples 1-7 can optionally include that the processor circuitry implements the first node, the second node, or a server, the server to be in communication with at least one of the first node or the second node.

In Example 9, the subject matter of Examples 1-8 can optionally include that the processor circuitry is to retrain the portion of the machine learning model locally at the first node or the second node.

Example 10 includes a non-transitory computer readable storage medium comprising instructions that, when executed, cause processor circuitry to at least retrain a portion of a machine learning model based on context data from a first node, and cause deployment of the portion of the machine learning model to at least one of the first node or a second node to execute a workload, the second node associated with the context data.

In Example 11, the subject matter of Example 10 can optionally include that the instructions cause the processor circuitry to determine the context data associated with the first node based on an identifier of the first node.

In Example 12, the subject matter of Examples 10-11 can optionally include that the instructions cause the processor circuitry to determine that the context data includes at least one of a device type of the first node, a physical location of the first node, a type of sensor associated with the first node, environmental data associated with the first node, performance information associated with the first node, age information associated with the first node, hardware information associated with the first node, or software information associated with the first node.

In Example 13, the subject matter of Examples 10-12 can optionally include that the portion of the machine learning model is a second portion of the machine learning model, the context data is second context data, and the instructions cause the processor circuitry to initialize the machine learning model for at least one of the first node or the second node, the first node associated with a first environment, the second node associated with at least one of the first environment or a second environment, arrange first portions of the machine learning model into respective groups based on first context data, the first portions including the second portion, the first context data including at least one of the second context data or third context data, the third context data associated with the second node, and output weights for the first portions of the machine learning model based on training data.

In Example 14, the subject matter of Examples 10-13 can optionally include that the first portions include a third portion, and the instructions cause the processor circuitry to arrange the second portion of the machine learning model associated with at least one of the first node or the second node into a first group of the respective groups, the first group based on at least one of the second context data or the third context data, and arrange a third portion of the machine learning model associated with a third node into a second group of the respective groups, the second group based on third context data associated with the third node.

In Example 15, the subject matter of Examples 10-14 can optionally include that the instructions cause the processor circuitry to collect first weights for the portion of the machine learning model from the first node, the first weights generated by the first node based on a condition at the first node, identify the context data associated with the first node based on an identifier of the first node, select the portion of the machine learning model based on the context data, change values of second weights associated with the portion with the first weights from the first node to retrain the portion of the machine learning model, and cause transmission of the first weights to at least one of the second node or a third node, the third node associated with the context data.

In Example 16, the subject matter of Examples 10-15 can optionally include that the machine learning model includes first layers, and the instructions cause the processor circuitry to generate a second layer of the machine learning model based on a creation of connections between the second layer and ones of the first layers, the ones of the first layers corresponding to a subset of the machine learning model associated with a condition at the first node, change values of weights of the ones of the first layers based on the condition, and execute the portion of the machine learning model that corresponds to the ones of the first layers at least one of the first node or the second node.

In Example 17, the subject matter of Examples 10-16 can optionally include that the instructions cause the processor circuitry to instantiate the first node, the second node, or a server in communication with at least one of the first node or the second node.

Example 18 includes an apparatus comprising means for retraining a portion of a machine learning model based on context data from a first node, and means for causing deployment of the portion of the machine learning model to at least one of the first node or a second node to execute a workload, the second node associated with the context data.

In Example 19, the subject matter of Example 18 can optionally include means for identifying the context data as associated with the first node based on an identifier of the first node.

In Example 20, the subject matter of Examples 18-19 can optionally include means for identifying the context data to include at least one of a device type of the first node, a physical location of the first node, a type of sensor associated with the first node, environmental data associated with the first node, performance information associated with the first node, age information associated with the first node, hardware information associated with the first node, or software information associated with the first node.

In Example 21, the subject matter of Examples 18-20 can optionally include that the portion of the machine learning model is a second portion of the machine learning model, the context data is second context data, and the means for retraining is to instantiate the machine learning model for at least one of the first node or the second node, the first node associated with a first environment, the second node associated with at least one of the first environment or a second environment, cluster first portions of the machine learning model into respective groups based on first context data, the first portions including the second portion, the first context data including at least one of the second context data or third context data, the third context data associated with the second node, and determine weights for the first portions of the machine learning model based on training data.

In Example 22, the subject matter of Examples 18-21 can optionally include that the first portions include a third portion, and the means for retraining is to cluster the second portion of the machine learning model associated with at least one of the first node or the second node into a first group of the respective groups, the first group based on at least one of the second context data or the third context data, and cluster a third portion of the machine learning model associated with a third node into a second group of the respective groups, the second group based on third context data associated with the third node.

In Example 23, the subject matter of Examples 18-22 can optionally include means for obtaining first weights for the portion of the machine learning model from the first node, the first weights generated by the first node based on a label associated with a condition observed by the first node, means for identifying the context data as associated with the first node based on an identifier of the first node, the means for retraining is to identify the portion of the machine learning model based on the context data, and update second weights associated with the portion with the first weights from the first node to retrain the portion of the machine learning model, and means for causing transmission of the first weights to at least one of the second node or a third node, the third node associated with the context data.

In Example 24, the subject matter of Examples 18-23 can optionally include that the machine learning model includes first layers, and wherein the means for retraining is to instantiate a second layer of the machine learning model based on a generation of connections between the second layer and ones of the first layers that correspond to a label from the first node, the label associated with a condition observed by the first node, and update weights of the ones of the first layers based on the label, and the means for causing is to cause deployment the portion of the machine learning model that corresponds to the ones of the first layers to at least one of the first node or the second node.

Example 25 includes a method for clustered federated learning, the method comprising retraining a portion of a machine learning model based on context data from a first node, and causing a deployment of the portion of the machine learning model to at least one of the first node or a second node to execute a workload, the second node associated with the context data.

In Example 26, the subject matter of Example 25 can optionally include determining that the context data is associated with the first node based on an identifier of the first node.

In Example 27, the subject matter of Examples 25-26 can optionally include determining that the context data includes at least one of a device type of the first node, a physical location of the first node, a type of sensor associated with the first node, environmental data associated with the first node, performance information associated with the first node, age information associated with the first node, hardware information associated with the first node, or software information associated with the first node.

In Example 28, the subject matter of Examples 25-27 can optionally include that the portion of the machine learning model is a second portion of the machine learning model, the context data is second context data, and the method further including instantiating the machine learning model for at least one of the first node or the second node, the first node associated with a first environment, the second node associated with at least one of the first environment or a second environment, clustering first portions of the machine learning model into respective groups based on first context data, the first portions including the second portion, the first context data including at least one of the second context data or third context data, the third context data associated with the second node, and determining weights for the first portions of the machine learning model based on training data.

In Example 29, the subject matter of Examples 25-28 can optionally include that the first portions include a third portion, and the method further including clustering the second portion of the machine learning model associated with at least one of the first node or the second node into a first group of the respective groups, the first group based on at least one of the second context data or the third context data, and clustering a third portion of the machine learning model associated with a third node into a second group of the respective groups, the second group based on third context data associated with the third node.

In Example 30, the subject matter of Examples 25-29 can optionally include obtaining first weights for the portion of the machine learning model from the first node, the first weights generated by the first node based on a label associated with an event observed by the first node, determining the context data associated with the first node based on an identifier of the first node, identifying the portion of the machine learning model based on the context data, updating second weights associated with the portion with the first weights from the first node to retrain the portion of the machine learning model, and causing a transmission of the first weights to at least one of the second node or a third node, the third node associated with the context data.

In Example 31, the subject matter of Examples 25-30 can optionally include that the machine learning model includes first layers, and the method further including in response to a determination that a label corresponds to a subset of the machine learning model, instantiating a second layer of the machine learning model based on a generation of connections between the second layer and ones of the first layers that correspond to the subset of the machine learning model, the label associated with an event observed by the first node, updating weights of the ones of the first layers based on the label, and causing deployment of the portion of the machine learning model that corresponds to the ones of the first layers to at least one of the first node or the second node.

In Example 32, the subject matter of Examples 25-31 can optionally include retraining the portion of the machine learning model locally at least one of the first node or the second node.

Example 33 includes a system comprising a first node to execute a portion of a machine learning model, a second node to generate weights of the portion of the machine learning model based on retraining of the portion of the machine learning model with sensor data associated with the second node, the retraining based on context data associated with the second node, and a server to deploy the weights to the first node based on a determination that the context data is associated with the first node, the first node to update the portion of the machine learning model at the first node based on the weights.

In Example 34, the subject matter of Example 33 can optionally include that the weights are first weights, the context data is first context data, the sensor data is first sensor data, the portion is a first portion, and the server is to generate second weights of a second portion of the machine learning model based on retraining of the machine learning model with second sensor data associated with a third node, the retraining based on second context data associated with the third node, and deploy the second weights to at least one of the first node or the second node based on a determination that the second context data is associated with the at least one of the first node or the second node.

In Example 35, the subject matter of Examples 33-34 can optionally include that the second node is to cause transmission of the weights to the first node.

In Example 36, the subject matter of Examples 33-35 can optionally include that the server is to determine that the context data is associated with the first node based on an identifier of the first node.

In Example 37, the subject matter of Examples 33-36 can optionally include that at least one of the second node or the server is to determine that the context data includes at least one of a device type of the second node, a physical location of the second node, a type of sensor associated with the second node, environmental data associated with the second node, performance information associated with the second node, age information associated with the second node, hardware information associated with the second node, or software information associated with the second node.

In Example 38, the subject matter of claims 33-37 can optionally include that at least one of the first node or the second node is to retrain the portion of the machine learning model locally to the at least one of the first node or the second node.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus for clustered federated learning, the apparatus comprising:
at least one memory;
instructions; and
processor circuitry to at least one of instantiate or execute the instructions to:
retrain a portion of a machine learning model based on context data from a first node; and
cause deployment of the portion of the machine learning model to at least one of the first node or a second node to execute a workload, the second node associated with the context data.

2. The apparatus of claim 1, wherein the processor circuitry is to determine the context data associated with the first node based on an identifier of the first node.

3. The apparatus of claim 1, wherein the processor circuitry is to determine that the context data includes at least one of a device type of the first node, a physical location of the first node, a type of sensor associated with the first node, environmental data associated with the first node, performance information associated with the first node, age information associated with the first node, hardware information associated with the first node, or software information associated with the first node.

4. The apparatus of claim 1, wherein the portion of the machine learning model is a second portion of the machine learning model, the context data is second context data, and the processor circuitry is to:
instantiate the machine learning model for at least one of the first node or the second node, the first node associated with a first environment, the second node associated with at least one of the first environment or a second environment;
cluster first portions of the machine learning model into respective groups based on first context data, the first portions including the second portion, the first context data including at least one of the second context data or third context data, the third context data associated with the second node; and
determine weights for the first portions of the machine learning model based on training data.

5. The apparatus of claim 4, wherein the first portions include a third portion, and the processor circuitry is to:
cluster the second portion of the machine learning model associated with at least one of the first node or the second node into a first group of the respective groups, the first group based on at least one of the second context data or the third context data; and
cluster a third portion of the machine learning model associated with a third node into a second group of the respective groups, the second group based on third context data associated with the third node.

6. The apparatus of claim 1, wherein the processor circuitry is to:
obtain first weights for the portion of the machine learning model from the first node, the first weights generated by the first node based on a label from the first node corresponding to an event observed by the first node;
determine the context data associated with the first node based on an identifier of the first node;
identify the portion of the machine learning model based on the context data;
update second weights associated with the portion with the first weights from the first node to retrain the portion of the machine learning model; and
cause transmission of the first weights to at least one of the second node or a third node, the third node associated with the context data.

7. The apparatus of claim 1, wherein the machine learning model includes first layers, and the processor circuitry is to:
instantiate a second layer of the machine learning model based on a generation of connections between the second layer and ones of the first layers, the ones of the first layers corresponding to a subset of the machine learning model associated with a label, the label corresponding to an event observed by the first node;
update weights of the ones of the first layers based on the label; and
cause deployment of the portion of the machine learning model that corresponds to the ones of the first layers to at least one of the first node or the second node.

8. The apparatus of claim 1, wherein the processor circuitry implements the first node, the second node, or a server, the server to be in communication with at least one of the first node or the second node.

9. The apparatus of claim 8, wherein the processor circuitry is to retrain the portion of the machine learning model locally at the first node or the second node.

10. A non-transitory computer readable storage medium comprising instructions that, when executed, cause processor circuitry to at least:
retrain a portion of a machine learning model based on context data from a first node; and
cause deployment of the portion of the machine learning model to at least one of the first node or a second node to execute a workload, the second node associated with the context data.

11. (canceled)

12. (canceled)

13. The non-transitory computer readable storage medium of claim 10, wherein the portion of the machine learning model is a second portion of the machine learning model, the context data is second context data, and the instructions cause the processor circuitry to:
initialize the machine learning model for at least one of the first node or the second node, the first node associated with a first environment, the second node associated with at least one of the first environment or a second environment;
arrange first portions of the machine learning model into respective groups based on first context data, the first portions including the second portion, the first context data including at least one of the second context data or third context data, the third context data associated with the second node; and
output weights for the first portions of the machine learning model based on training data.

14. The non-transitory computer readable storage medium of claim 13, wherein the first portions include a third portion, and the instructions cause the processor circuitry to:
arrange the second portion of the machine learning model associated with at least one of the first node or the second node into a first group of the respective groups, the first group based on at least one of the second context data or the third context data; and
arrange a third portion of the machine learning model associated with a third node into a second group of the respective groups, the second group based on third context data associated with the third node.

15. The non-transitory computer readable storage medium of claim 10, wherein the instructions cause the processor circuitry to:
collect first weights for the portion of the machine learning model from the first node, the first weights generated by the first node based on a condition at the first node;
identify the context data associated with the first node based on an identifier of the first node;
select the portion of the machine learning model based on the context data;
change values of second weights associated with the portion with the first weights from the first node to retrain the portion of the machine learning model; and
cause transmission of the first weights to at least one of the second node or a third node, the third node associated with the context data.

16. The non-transitory computer readable storage medium of claim 10, wherein the machine learning model includes first layers, and the instructions cause the processor circuitry to:
generate a second layer of the machine learning model based on a creation of connections between the second layer and ones of the first layers, the ones of the first layers corresponding to a subset of the machine learning model associated with a condition at the first node;
change values of weights of the ones of the first layers based on the condition; and
execute the portion of the machine learning model that corresponds to the ones of the first layers at least one of the first node or the second node.

17-24. (canceled)

25. A method for clustered federated learning, the method comprising:
retraining a portion of a machine learning model based on context data from a first node; and
causing a deployment of the portion of the machine learning model to at least one of the first node or a second node to execute a workload, the second node associated with the context data.

26. (canceled)

27. The method of claim 25, further including determining that the context data includes at least one of a device type of the first node, a physical location of the first node, a type of sensor associated with the first node, environmental data associated with the first node, performance information associated with the first node, age information associated with the first node, hardware information associated with the first node, or software information associated with the first node.

28. (canceled)

29. The method of claim 28, wherein the first portions include a third portion, and the method further including:
clustering the second portion of the machine learning model associated with at least one of the first node or the second node into a first group of the respective groups, the first group based on at least one of the second context data or the third context data; and
clustering a third portion of the machine learning model associated with a third node into a second group of the respective groups, the second group based on third context data associated with the third node.

30. The method of claim 25, further including:
obtaining first weights for the portion of the machine learning model from the first node, the first weights generated by the first node based on a label associated with an event observed by the first node;
determining the context data associated with the first node based on an identifier of the first node;
identifying the portion of the machine learning model based on the context data;
updating second weights associated with the portion with the first weights from the first node to retrain the portion of the machine learning model; and
causing a transmission of the first weights to at least one of the second node or a third node, the third node associated with the context data.

31. The method of claim 25, wherein the machine learning model includes first layers, and the method further including:
in response to a determination that a label corresponds to a subset of the machine learning model, instantiating a second layer of the machine learning model based on a generation of connections between the second layer and ones of the first layers that correspond to the subset of the machine learning model, the label associated with an event observed by the first node;
updating weights of the ones of the first layers based on the label; and
causing deployment of the portion of the machine learning model that corresponds to the ones of the first layers to at least one of the first node or the second node.

32. (canceled)

33. A system comprising:
a first node to execute a portion of a machine learning model;
a second node to generate weights of the portion of the machine learning model based on retraining of the portion of the machine learning model with sensor data associated with the second node, the retraining based on context data associated with the second node; and
a server to deploy the weights to the first node based on a determination that the context data is associated with the first node, the first node to update the portion of the machine learning model at the first node based on the weights.

34. The system of claim 33, wherein the weights are first weights, the context data is first context data, the sensor data is first sensor data, the portion is a first portion, and the server is to:
generate second weights of a second portion of the machine learning model based on retraining of the machine learning model with second sensor data associated with a third node, the retraining based on second context data associated with the third node; and
deploy the second weights to at least one of the first node or the second node based on a determination that the second context data is associated with the at least one of the first node or the second node.

35. The system of claim 33, wherein the second node is to cause transmission of the weights to the first node.

36. The system of claim 33, wherein the server is to determine that the context data is associated with the first node based on an identifier of the first node.

37. The system of claim 33, wherein at least one of the second node or the server is to determine that the context data includes at least one of a device type of the second node, a physical location of the second node, a type of sensor associated with the second node, environmental data associated with the second node, performance information associated with the second node, age information associated with the second node, hardware information associated with the second node, or software information associated with the second node.

38. The system of claim 33, wherein at least one of the first node or the second node is to retrain the portion of the machine learning model locally to the at least one of the first node or the second node.
